(19) United States
(12) Patent Application Publication
(10) Pub. No.: US 2008/0044587 A1
(43) Pub. Date: Feb. 21, 2008

(54) Inkjet recording method and apparatus

(75) Inventors: Yutaka Maeno, Kanagawa-ken (JP); Toshiyuki Makuta, Shizuoka-ken (JP); Tetsuzo Kadomatsu, Kanagawa-ken (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/889,414

(22) Filed: Aug. 13, 2007

(30) Foreign Application Priority Data
Aug. 16, 2006 (JP) 2006-222002

(51) Int. Cl. B41J 2/325; B05D 3/06

(52) U.S. Cl. 427/487; 347/213

(57) ABSTRACT

The inkjet recording method includes the steps of: applying a liquid on an intermediate transfer body, the liquid containing an energy-beam polymerizable compound and a coloring material, the energy-beam polymerizable compound being constituted of a monofunctional polymerizable compound of which percentage in the energy-beam polymerizable compound is not less than 99 wt % and not more than 100 wt %; radiating an energy beam on the liquid that has been applied on the intermediate transfer body, to produce a polymer of the liquid; and transferring the polymer on the intermediate transfer body to a recording medium by pressurizing and heating the polymer to a temperature not lower than a softening temperature of the polymer.

### BACKGROUND OF THE INVENTION

1. Field of the Invention

The present invention relates to an inkjet recording method and apparatus, and more particularly, to an inkjet recording method and apparatus using a method (intermediate transfer method) in which an image recorded onto an intermediate transfer body using an energy-curable ink is transferred to a recording medium such as a recording paper.

2. Description of the Related Art

An inkjet recording apparatus (a so-called direct recording apparatus) has been known which adopts a method of forming a desired image by ejecting droplets of ink directly onto a recording medium and which is suitable for recording onto a recording medium (low permeability media or non-permeable media) that has low ink permeability, such as coated papers. However, in the case of a recording medium (permeable media) having high permeability, such as normal paper, the ink liquid permeates into the recording medium, and image deterioration occurs due to ink bleeding or dot spreading (dot shape abnormality), or the like.

In order to avoid problems of this kind, Japanese Patent Application Publication No. 10-250052 discloses a method in which a primary image is formed on an intermediate transfer body by using an ultraviolet-curable ink (UV ink) which is cured when irradiated with ultraviolet light, and the viscosity of the ink on the intermediate transfer body is raised by radiating ultraviolet light onto same, whereupon the primary image is transferred to a paper forming the recording medium.

Furthermore, Japanese Patent Application Publication No. 2005-161603 discloses technology which improves the image quality and the adhesive characteristics by heating an energy-curable ink which has been cured on an intermediate transfer body, to a temperature equal to or higher than the glass transition temperature (T_{g}) during transfer of the ink, thereby improving the image quality and the adhesive characteristics.

However, in the case of an inkjet recording apparatus which uses an energy-curable ink, such as UV ink, since the energy-curable ink is cured without any evaporation of material, then the pile height (the height of the dot spheres) of the ink dots becomes larger, and there is a problem in that the image regions formed by the ink protrude upwards with respect to the non-image regions (the regions where ink has not been deposited). In other words, due to the pile height, a height difference occurs between the image regions and the non-image regions on the recording side of the recording medium, and these undulations are perceived as roughness on the image surface.

Moreover, in an inkjet recording apparatus of an intermediate transfer type which uses an energy curable ink, in order to improve the transfer rate (the ratio of ink transferred from the intermediate transfer body to the recording medium), it is desirable that the surface of the intermediate transfer body be made of a material having a low surface energy (for example, a surface coating made of silicon rubber, fluorine resin, or the like). However, in the case of the intermediate transfer body having a low surface energy, when ink droplets are ejected and deposited on the intermediate transfer body, then there is a problem in that insufficient spreading of the dots is achieved due to ink-repelling properties of the surface of the intermediate transfer body.

Japanese Patent Application Publication No. 2005-161603 discloses a technology that dots of ink that has been cured on an intermediate transfer medium are transferred to the recording medium while pressurized and heated to a temperature above the glass transition temperature (Tg), thereby improving the roughness of the image, the adhesive properties and the furrow (wrinkling) properties.

However, simply heating the ink on the intermediate transfer medium to a temperature above the glass transition temperature, as described in Japanese Patent Application Publication No. 2005-161603, only causes the cured ink to assume rubber elastic properties, and is not sufficient for causing the ink to soften (undergo plastic deformation). In particular, in the case of ink which includes a polyfunctional monomer as a polymerizable compound, as described in a working example of Japanese Patent Application Publication No. 2005-161603, since the polymer chains are cross-linked to each other by means of covalent bonds, then even when the material is heated to a temperature equal to or higher than the glass transition temperature, the covalent bonds are preserved and the material does not soften.

FIG. 11A is a schematic drawing of a polymer which is cross-linked and FIG. 11B is a schematic drawing of a polymer which is not cross-linked. In the cross-linked polymer shown in FIG. 11A, even when the temperature is raised, the cross-links 512 are not undone and softening does not occur. On the other hand, in the case of the non-cross-linked polymer shown in FIG. 11B, when the temperature is raised, then the polymer chains loosen from each other and produces softening (thermoplastic deformation), as indicated by the regions inside the dotted circles in FIG. 11B.

### SUMMARY OF THE INVENTION

By considering the issues described above, the present inventors discovered that in the inkjet recording apparatus based on the intermediate transfer method, it is important that the cured ink material should have thermoplastic properties (thermal plasticity) in order for the ink dots to be crushed and spread sufficiently upon transfer. Japanese Patent Application Publication Nos. 10-250052 and 2005-161603 make no mention at all of these issues, and they do not clearly state the conditions, and the like, for achieving thermoplastic properties in the cured ink material.

The present invention has been contrived in view of the foregoing circumstances, an object thereof being to provide an inkjet recording method and apparatus of intermediate transfer type whereby transfer properties (the transfer rate) can be improved, and the fixing properties and adhesive properties on the recording medium can be improved.

In order to attain the aforementioned object, the present invention is directed to an inkjet recording method, comprising the steps of: applying a liquid on an intermediate transfer body, the liquid containing an energy-beam polymerizable compound and a coloring material, the energy-beam polymerizable compound being constituted of a monofunctional polymerizable compound of which percentage in the energy-beam polymerizable compound is not less than 99 wt % and not more than 100 wt %; radiating an energy beam on the liquid that has been applied on the intermediate transfer body, to produce a polymer of the liquid; and transferring the polymer on the intermediate transfer body to a recording medium by pressurizing and heating the polymer to a temperature not lower than a softening temperature of the polymer.

In this aspect of the present invention, the ratio of a monofunctional polymerizable compound in the energy beam-polymerizable compound contained in the liquid (energy beam-curable ink) is not less than 99 wt % and not more than 100 wt %, and the ratio of the monofunctional polymerizable compound is sufficiently high for the composition to be treated as one which substantially contains a monofunctional polymerizable compound only. In other words, even if a substance other than the monofunctional polymerizable compound (such as a polyfunctional polymerizable compound) is contained as an energy beam-polymerizable compound, the ratio of this substance is kept within a range of not greater than 1 wt %.

Since the polymer of the monofunctional polymerizable compound has thermal plasticity, then it can be deformed readily when heated to a temperature equal to or higher than the softening point (softening temperature), and therefore the dots of the polymer material are crushed and spread when being pressurized and heated to a temperature equal to or higher than the softening point. As well as reducing the pile height, it is also possible to improve transfer characteristics onto the recording medium, and adhesive properties.

The type of monofunctional monomer may be selected so that the cured material has a desired softening point, and it is also possible to use a combination of a plurality of types of monomers.

The energy beam may be visible light, ultraviolet light, electromagnetic waves including X rays, an electron beam, or the like, and a typical example of the energy-beam curable ink is an ultraviolet-curable ink (UV ink), or an electron beam curable ink (EB ink).

Preferably, a size of a dot of the polymer having been transferred to the recording medium in the transferring step is 1.2 or more times larger than a size of a corresponding dot of the polymer on the intermediate transfer body before the transferring step.

The dots on the intermediate transfer body are transferred to a recording medium when being pressurized and heated to a temperature equal to or higher than the softening point (softening temperature), and in this case, if the diameter of the dots formed on the recording medium (after transfer), is 1.2 or more times, and more desirably, 1.4 or more times, larger than the diameter of the dots on the intermediate transfer body (before transfer), then marked beneficial effects in reducing the pile height can be achieved.

Preferably, the liquid contains a photopolymerization initiator, and the energy beam is ultraviolet light.

For the “liquid” in the present invention, it is possible to appropriately use an ultraviolet-curable ink, for example, which is one type of energy beam-curable ink.

Preferably, the photopolymerization initiator is a photopolymerization radical generator.

Photopolymerization initiators are broadly categorized into radical-type, cationic-type and anionic-type, depending on the active species produced. A photopolymerization initiator of radical type is beneficial in that the curing speed is faster than other photopolymerization initiators of cationic-type and anionic-type.

In order to attain the aforementioned object, the present invention is also directed to an inkjet recording apparatus which transfers an image on an intermediate transfer body to a recording medium, comprising: a liquid ejection device which ejects droplets of a liquid toward the intermediate transfer body, the liquid containing an energy-beam polymerizable compound and a coloring material, the energy-beam polymerizable compound being constituted of a monofunctional polymerizable compound of which percentage in the energy-beam polymerizable compound is not less than 99 wt % and not more than 100 wt %; a liquid supply device which supplies the liquid to the liquid ejection device; an energy-beam irradiation device which radiates an energy beam on the droplets of the liquid that have been deposited on the intermediate transfer body by the liquid ejection device, to produce a polymer of the liquid; a heating device which heats the polymer of the liquid produced by irradiation of the energy beam, to a temperature not lower than a softening temperature of the polymer; and a pressurizing device which pressurizes the polymer that has been heated to the temperature not lower than the softening temperature by the heating device, while causing the polymer to be in contact with the recording medium.

According to the present invention, it is possible to reduce the pile height, and it is also possible to improve the transfer characteristics and the adhesive properties on the recording medium.

### BRIEF DESCRIPTION OF THE DRAWINGS

The nature of this invention, as well as other objects and benefits thereof, will be explained in the following with reference to the accompanying drawings, in which like reference characters designate the same or similar parts throughout the figures and wherein:

FIG. 1 is a schematic drawing of an inkjet recording apparatus according to a first embodiment of the present invention;

FIG. 2 is a principal plan diagram of the peripheral area of a print unit in the inkjet recording apparatus shown in FIG. 1;

FIGS. 3A to 3C are plan view perspective diagrams showing examples of the composition of a print head;

FIG. 4 is a cross-sectional view along line 4-4 in FIGS. 3A and 3B;

FIG. 5 is an approximate diagram showing the composition of an ink supply system of the inkjet recording apparatus shown in FIG. 1;

FIG. 6 is a principal block diagram showing the system configuration of the inkjet recording apparatus shown in FIG. 1;

FIG. 7 is an enlarged schematic drawing showing the principal part of the transfer unit of the inkjet recording apparatus shown in FIG. 1;

FIG. 8 is a table showing the evaluation results regarding transfer characteristics and pile height;

FIG. 9 is a schematic drawing of an inkjet recording apparatus according to a second embodiment of the present invention;

FIG. 10 is a schematic drawing of an inkjet recording apparatus according to a third embodiment of the present invention;

FIG. 11A is a schematic drawing for illustrating a polymer which is cross-linked; and

FIG. 11B is a schematic drawing for illustrating a polymer which is not cross-linked.

### DETAILED DESCRIPTION OF THE PREFERRED EMBODIMENTS

### First Embodiment: Composition of Apparatus

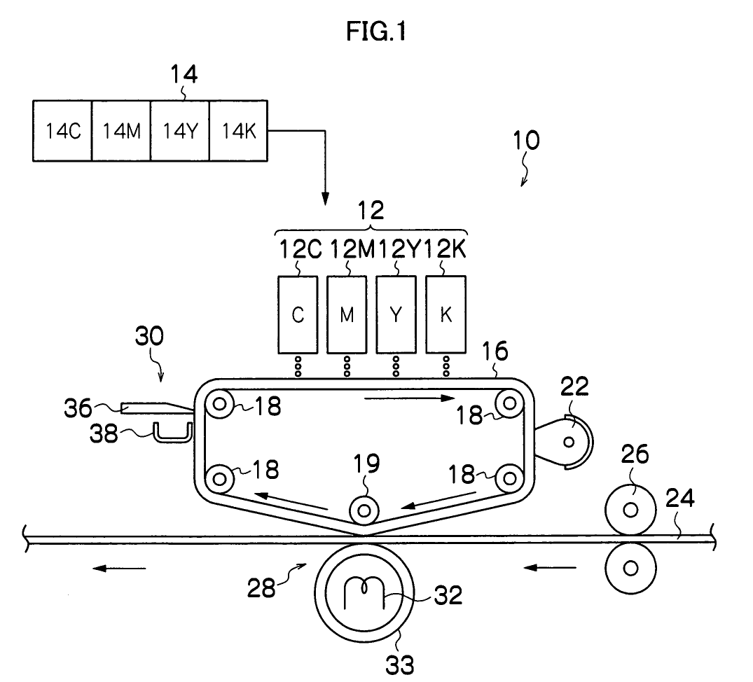

FIG. 1 is a schematic drawing of an inkjet recording apparatus according to a first embodiment of the present invention. As shown in FIG. 1, the inkjet recording apparatus 10 includes: a print unit 12 having a plurality of inkjet heads (hereinafter called “heads”) 12C, 12M, 12Y and 12K corresponding to inks of respective colors of cyan (C), magenta (M), yellow (Y) and black (K); an ink storing and loading unit 14 which stores inks to be supplied to the respective heads 12C, 12M, 12Y and 12K; and an intermediate transfer body 16 on which an image (primary image) is formed by means of inks ejected as droplets from the heads 12C, 12M, 12Y and 12K.

The inks used in the present embodiment are ultraviolet-curable inks, each of which contains an ultraviolet-polymerizable compound and a coloring material (e.g., pigment) of the corresponding color. The polymerizable compound in the ink is mainly composed of a monofunctional monomer (99 wt % or more), in such a manner that the polymerizable compound contained in the ink is substantially composed of monofunctional monomer only. The details of the ink composition are described hereinafter.

The ink storing and loading unit 14 has ink tanks 14C, 14M, 14Y, and 14K, for storing the inks of K, C, M and Y to be supplied to the heads 12C, 12M, 12Y and 12K, and the tanks are connected to the heads 12C, 12M, 12Y and 12K by means of prescribed flow channels. The ink storing and loading unit 14 has a warning device (for example, a display device or an alarm sound generator) for warning when the remaining amount of any ink is low, and has a mechanism for preventing loading errors among the colors.

In other words, the heads 12C, 12M, 12Y and 12K of the print unit 12 correspond to the “liquid ejection device”, and the ink storing and loading unit 14 and the flow channels of the supply system correspond to the “liquid supply device”.

As shown in FIG. 1, an endless belt member is used for the intermediate transfer body 16. The intermediate transfer body 16, which is made of an endless belt member, is wound around a plurality of spanning rollers 18 and a transfer pressurization opposition roller 19, and at least the portion of the belt surface which opposes the nozzle face (ink ejection face) of the print unit 12 and on which a primary image is formed by the print unit 12, is configured to have a horizontal surface (flat surface). Moreover, the whole of the intermediate transfer body 16 or at least a portion of the belt surface which includes the image forming region where deposition of ink ejected by the print unit 12 is intended (predicted), is made of a material that is not permeable (non-permeable) to the liquid droplets, such as resin or metal.

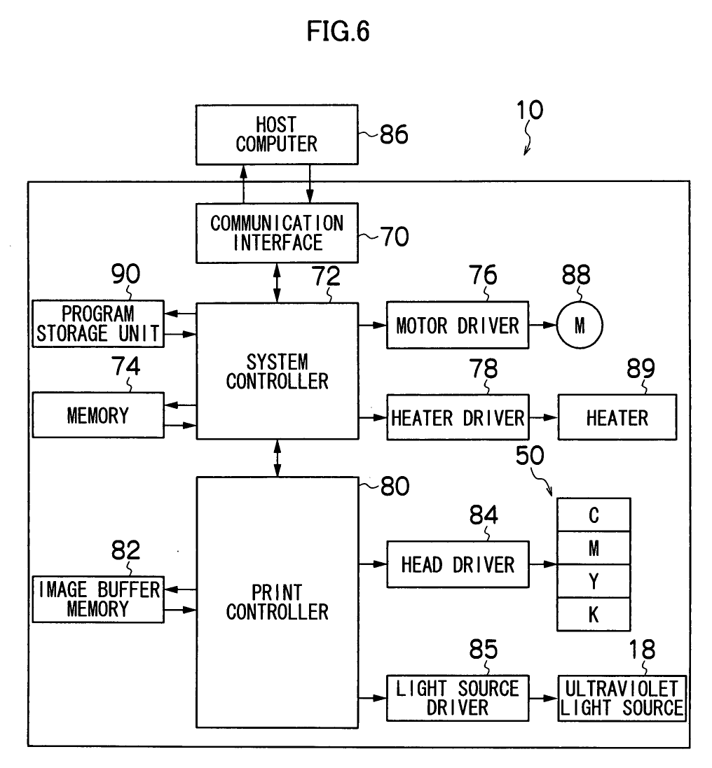

By transmitting the motive force of a motor (not shown in FIG. 1 and indicated by reference numeral 88 in FIG. 6) to at least one of the plurality of spanning rollers 18 and the opposition roller 19 about which the intermediate transfer body 16 is wound, the intermediate transfer body 16 is driven in the clockwise direction in FIG. 1.

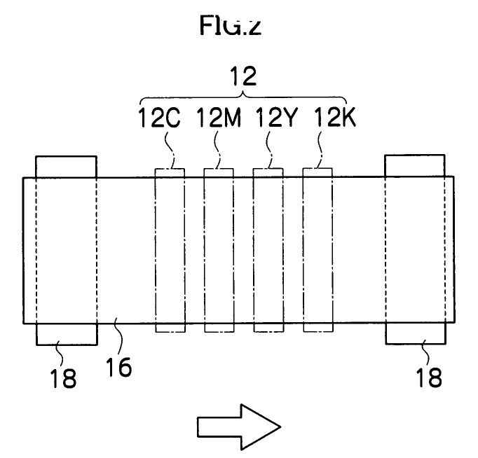

The respective heads 12C, 12M, 12Y and 12K of the print unit 12 are each full-line heads having a length corresponding to the maximum width of the image forming region on the intermediate transfer body 16 (the image forming region). In each of the heads (full-line heads) 12C, 12M, 12Y and 12K, a plurality of nozzles for ejecting ink are arranged in the nozzle face of the head through the full width of the image forming region (see FIG. 2).

The heads 12C, 12M, 12Y and 12K are arranged following the conveyance direction of the intermediate transfer body 16, in the color order, cyan (C), magenta (M), yellow (Y) and black (K), from the upstream side in terms of the conveyance direction, and these respective heads 12C, 12M, 12Y and 12K are fixed so as to extend in a direction perpendicular to the conveyance direction of the intermediate transfer body 16.

An image (primary image) can be formed on the intermediate transfer body 16 by ejecting the inks from the heads 12C, 12M, 12Y and 12K, respectively, onto the intermediate transfer body 16 while conveying the intermediate transfer body 16.

By adopting a configuration in which full line heads 12C, 12M, 12Y and 12K having nozzle rows covering the full width of the intermediate transfer body 16 are provided for each separate color in this way, it is possible to record an image on the image forming region of the intermediate transfer body 16 by performing just one operation of moving the intermediate transfer body 16 and the print unit 12, relatively, in the conveyance direction (the sub-scanning direction) of the intermediate transfer body 16 (in other words, by means of one sub-scanning action). Higher-speed printing is thereby made possible and print productivity can be improved in comparison with a serial (shuttle) type head configuration in which a head moves reciprocally in a direction which is perpendicular to the conveyance direction.

Although a configuration with the four standard colors of C, M, Y and K is described in the present embodiment, the combinations of the ink colors and the number of colors are not limited to those. Light and/or dark inks, and special color inks can be added as required. For example, a configuration is possible in which inkjet heads for ejecting light-colored inks, such as light cyan and light magenta, are added, and there is no particular restriction on the arrangement sequence of the heads of the respective colors.

Furthermore, the inkjet recording apparatus 10 includes: an ultraviolet light source 22 (corresponding to an “energy beam irradiation device”) which cures the ink by radiating ultraviolet light onto the ink deposited on the intermediate transfer body 16; a pair of media conveyance rollers 26 for supporting and conveying a recording medium 24; a transfer unit 28 for transferring a primary image on the intermediate transfer body 16, to the recording medium 24 conveyed by the nip of the pair of media conveyance rollers 26; and a cleaning unit 30 for removing the remaining ink deposited onto the intermediate transfer body 16, after transfer.

According to the composition described above, a primary image is formed on the intermediate transfer body 16 by depositing ink ejected from the heads 12C, 12M, 12Y and 12K of the print unit 12, onto the intermediate transfer body 16. With the movement of the intermediate transfer body 16, this primary image is moved in the clockwise direction in FIG. 1, and the primary image is irradiated with the ultraviolet light radiated from the ultraviolet light source 22.

The ink on the intermediate transfer body 16 is polymerized and cured by the irradiation of the ultraviolet light (energy) radiated from the ultraviolet light source 22, and is thereby fixed provisionally onto the intermediate transfer body 16 in the state of a cured ink material. The amount of ultraviolet light radiated (the energy density and the irradiation time) is controlled with a view to applying the energy required for curing the ink.

In order for the ink on the intermediate transfer body to be transferred to the recording medium in a substantially complete fashion, it is necessary that the ink droplets on the intermediate transfer body 16 be cured completely by the irradiation of ultraviolet light. It is undesirable that the liquid ink droplets are not cured completely and are in an intermediate state of increased viscosity, since a so-called “offset” phenomenon is liable to arise in which the ink remains on the intermediate transfer body as well as the recording medium.

The transfer unit 28 is provided on one side of the intermediate transfer body 16 opposite to the other side on which the flat image forming region facing the print unit 12 is arranged (in FIG. 1, the transfer unit 28 is provided in a position directly below the image forming region). A transfer heating roller 33 having a heater 32 is disposed in the transfer unit 28, and the intermediate transfer body 16 and the recording medium 24 are interposed between the transfer heating roller 33 and the pressurization nip opposition roller 19 which is disposed opposing the transfer heating roller 33, thereby pressurizing the intermediate transfer body 16 and the recording medium 24 at a prescribed pressure (nip pressure) while heating same to a prescribed temperature (a temperature equal to or higher than the softening temperature discussed below), in such a manner that the primary image on the intermediate transfer body 16 is transferred to the recording medium 24.

In other words, in the present embodiment, the transfer heating roller 33 having the heater 32 corresponds to a “heating device”, and the combination of this transfer pressurization roller 33 and the opposition roller 19 corresponds to a “pressurizing device”.

In order to adjust the nip pressure during transfer, for example, a mechanism (drive device) which moves the transfer heating roller 33 upwards and downwards in FIG. 1 is provided.

In this way, the image is transferred to the recording medium 24 and an image (secondary image) is formed on the recording medium 24 by passing through the transfer unit 28, and the printed object thus generated (the recording medium 24 formed with an image) is output from a print output section (not illustrated).

Concrete examples of the recording medium 24 includes: a permeable paper, such as a normal paper, a special inkjet paper, or the like; a non-permeable or low-permeability media, such as a coated paper; a sealing paper which has adhesive and a detachable label attached to the rear surface; a resin film such as an OHP sheet; and other types of media including a metal sheet, cloth, and wood.

Although not shown in FIG. 1, for the composition of the paper supply unit which supplies the recording medium 24, it is possible to adopt a mode including a magazine for rolled paper (continuous paper), or a mode in which paper is supplied by means of a cassette in which cut paper is stacked and loaded, instead of or in conjunction with the rolled paper. In the case of a configuration in which roll paper is used, a cutter is provided and the continuous paper is cut to a desired size by the cutter. It is also possible to use jointly a plurality of magazines or cassettes containing papers of different widths and qualities, and the like.

In the case of a configuration in which a plurality of types of recording medium can be used, it is preferable that an information recording medium such as a bar code and a wireless tag containing information about the type of medium is attached to the magazine, and by reading the information contained in the information recording medium with a predetermined reading device, the type of recording medium to be used (type of medium) is automatically determined, and ink-droplet ejection is controlled so that the ink-droplets are ejected in an appropriate manner in accordance with the type of medium.

Furthermore, the cleaning unit 30 which functions as a device for cleaning the intermediate transfer body 16 after transfer includes a blade 36 which removes residual ink while abutting against the intermediate transfer body 16 and a recovery unit 38 which recovers the residual ink thus removed. The composition of the cleaning device which removes the residual ink from the intermediate transfer body 16 is not limited to the embodiment given above, and it may adopt, for example, a configuration in which the intermediate transfer body 16 is nipped with a brush roller, a water absorbent roller or the like, or an air blowing configuration in which clean air is blown onto the intermediate transfer body 16, or a combination of these. In the case of a configuration in which the intermediate transfer body 16 is nipped with a cleaning roller, it is preferable to make the linear velocity of the cleaning roller different to that of the intermediate transfer body 16, in order to improve the cleaning effect.

### Structure of the Head

Next, the structure of a head is described below. The heads 12C, 12M, 12Y and 12K of the respective ink colors have the same structure, and a reference numeral 50 is hereinafter designated to any of the heads.

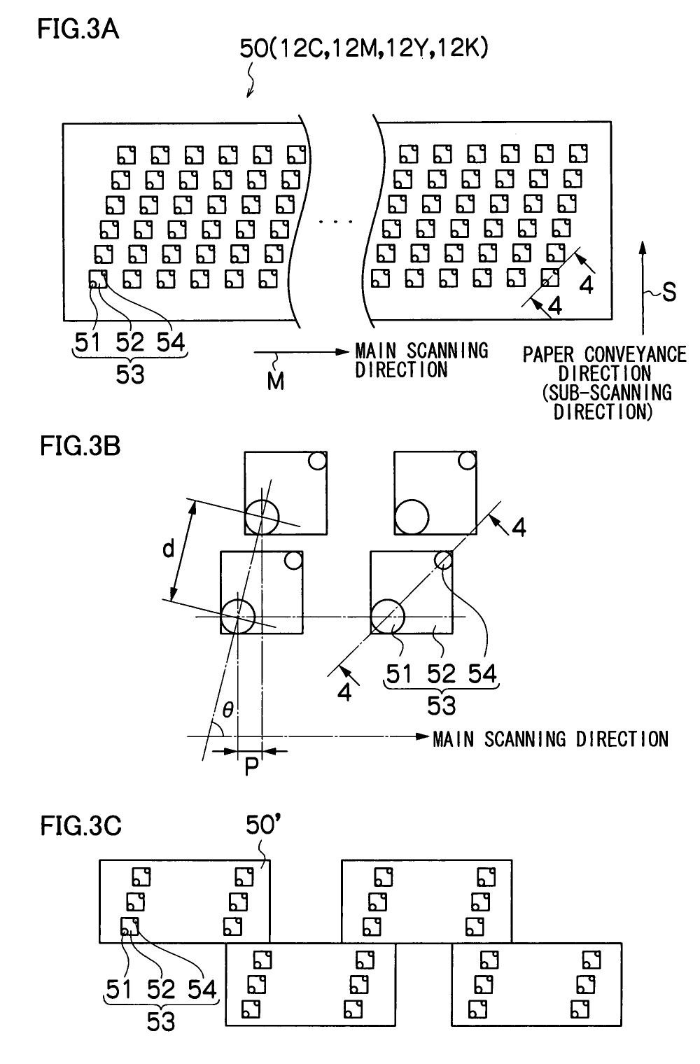

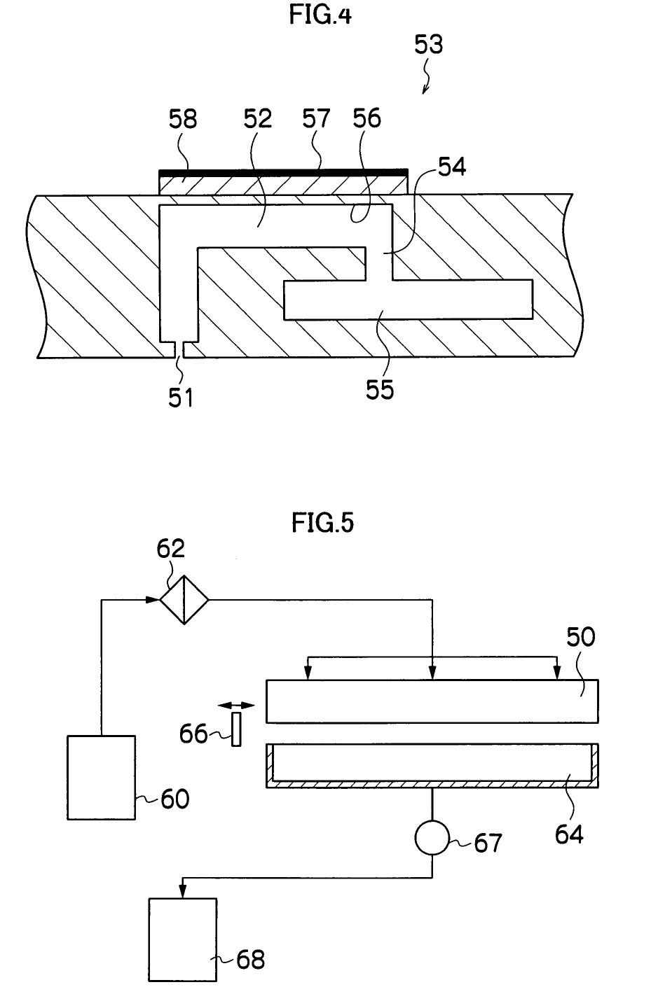

FIG. 3A is a plan view perspective diagram showing an example of the structure of a head 50, and FIG. 3B is an enlarged diagram of a portion of same. As shown in FIGS. 3A and 3B, this print head 50 has a structure in which a plurality of pressure chamber units (liquid droplet ejection elements) 53 are arranged in a matrix configuration (two-dimensionally), each pressure chamber unit including a nozzle 51 which ejects ink in the form of a droplet, a pressure chamber 52 corresponding to the nozzle 51, and an independent supply port 54 for supplying ink to the respective pressure chamber 52 from a common flow channel for ink supply (not shown in FIGS. 3A and 3B, but indicated by reference numeral 55 in FIG. 4).

As shown in FIGS. 3A and 3B, the planar shape of the pressure chamber 52 provided corresponding to each nozzle 51 is substantially a square shape, and an outlet port to the nozzle 51 is provided at one of the ends of the diagonal line of the planar shape, while an independent supply port 54 is provided at the other end thereof. The shape of the pressure chamber 52 is not limited to that of the present example and various modes are possible in which the planar shape is a quadrilateral shape (diamond shape, rectangular shape, or the like), a pentagonal shape, a hexagonal shape, or other polygonal shape, or a circular shape, elliptical shape, or the like.

By adopting a composition in which a plurality of pressure chamber units 53 having the composition described above are arranged in a lattice configuration according to a fixed arrangement pattern following a row direction in line with the lengthwise direction of the head (the direction of arrow M in FIG. 3A), and an oblique column direction having a fixed non-perpendicular angle θ with respect to the row direction, then high-density nozzle rows are achieved in which the effective nozzle pitch (projected nozzle pitch) when projected to an alignment in the lengthwise direction of the head (direction of arrow M) is a narrow pitch.

The mode of forming one or more nozzle rows through a length corresponding to the entire width of the recording medium 20 in a direction substantially perpendicular to the conveyance direction of the recording medium 20 (the direction of arrow S in FIG. 3A) is not limited to the example described above. For example, instead of the configuration in FIG. 3A, as shown in FIG. 3C, a line head having nozzle rows of a length corresponding to the entire width of the recording medium can be formed by arranging and combining, in a staggered matrix, short head module 50′ having a plurality of nozzles 51 arrayed in a two-dimensional fashion.

FIG. 4 is a cross-sectional diagram showing the three-dimensional composition of an ink chamber unit 53 (a cross-sectional diagram along line 4-4 in FIGS. 3A to 3C). As shown in FIG. 4, each pressure chamber 52 is connected to the common flow channel 55 via an individual supply port 54. The common flow channel 55 is connected to an ink tank (not shown in FIG. 4, but indicated by reference numerals 14C, 14M, 14Y and 14K in FIG. 1), which is a base tank that supplies ink, and the ink supplied from the ink tank is delivered through the common flow channel 55 in FIG. 4 to the pressure chambers 52.

Desirably, a uniform film is formed inside the ink flow channels, principally, in the pressure chambers, for example, a coating of polyparaxylylene (product name, parylene) is provided.

An actuator 58 provided with an individual electrode 57 is bonded to a pressure plate (a diaphragm that also serves as a common electrode) 56 which forms the surface of one portion (in FIG. 4, the ceiling) of the pressure chambers 52. When a drive voltage is applied to the individual electrode 57 and the common electrode, the actuator 58 deforms, thereby changing the volume of the pressure chamber 52. This causes a pressure change which results in ink being ejected from the nozzle 51. For the actuator 58, it is possible to adopt a piezoelectric element using a piezoelectric body, such as lead zirconate titanate, barium titanate, or the like. When the displacement of the actuator 58 returns to its original position after ejecting ink, the pressure chamber 52 is replenished with new ink from the common flow channel 55 via the independent supply port 54.

By controlling the driving of the actuators 58 corresponding to the nozzles 51 in accordance with the dot data generated from the data of the input image (original data of image to be printed), it is possible to eject ink droplets from the nozzles 51.

### Configuration of an Ink Supply System

FIG. 5 is a schematic drawing showing the configuration of the ink supply system in the inkjet recording apparatus 10. The ink tank 60 in FIG. 5 is a base tank that supplies ink to the head 50 and is set in the ink storing and loading unit 14 described with reference to FIG. 1. The aspects of the ink tank 60 include a refillable type and a cartridge type: when the remaining amount of ink is low, the ink tank 60 of the refillable type is filled with ink through a filling port (not shown) and the ink tank 60 of the cartridge type is replaced with a new one. In order to change the ink type in accordance with the intended application, the cartridge type is suitable, and it is preferable to represent the ink type information with a bar code, a wireless tag or the like on the cartridge, and to perform ejection control in accordance with the ink type.

A filter 62 for removing foreign matters and bubbles is disposed in a flow channel between the ink tank 60 and the head 50 as shown in FIG. 5. The filter mesh size in the filter 62 is preferably equivalent to or less than the diameter of the nozzle and commonly about 20 μm. Although not shown in FIG. 5, it is preferable to provide a sub-tank integrally to the print head 50 or nearby the head 50. The sub-tank has a damper function for preventing variation in the internal pressure of the head and a function for improving refilling of the print head.

Furthermore, the inkjet recording apparatus 10 is provided with a cap 64 forming a device for preventing increased viscosity and curing of ink on the nozzle face due to scattered light entered into the nozzles 51, and a cleaning blade 66 forming a nozzle surface cleaning device. A maintenance unit including the cap 64 and the cleaning blade 66 can be relatively moved with respect to the head 50 by a movement mechanism (not shown), and is moved from a predetermined holding position to a maintenance position below the head 50 as required.

The cap 64 is displaced up and down relatively with respect to the head 50 by an elevator mechanism (not shown). When the power of the inkjet recording apparatus 10 is turned OFF or when in a print standby state, the cap 64 is raised to a predetermined elevated position so as to come into close contact with the head 50, and the nozzle face is thereby covered with the cap 64.

The cleaning blade 66 is composed of rubber or another elastic member, and can slide on the ink ejection face (surface of the nozzle plate) of the head 50 by means of a blade movement mechanism (not shown). When ink droplets or foreign matters have adhered to the nozzle plate, the surface of the nozzle plate is wiped and cleaned by sliding the cleaning blade 66 on the nozzle plate.

During printing or during standby, if the use frequency of a particular nozzle has declined and the ink viscosity in the vicinity of that nozzle has increased, or the like, then according to requirements, a preliminary ejection (also called “dummy ejection”, “purge”, “spit ejection”, or the like) is performed toward the cap 64, in order to remove the degraded ink.

Moreover, if air bubbles become intermixed into the nozzles 51 and the pressure chambers 52, or if the increase in the viscosity of the ink inside the nozzles 51 has exceeded a certain level, then it becomes difficult to eject ink by means of preliminary ejection as described above, and in cases of this kind, the cap 64 is caused to come into contact with the nozzle surface of the head 50, and the ink inside the pressure chambers 52 (the ink into which air bubbles have become intermixed or ink of increased viscosity) is removed by suctioning by means of a suction pump 67. The ink suctioned and removed by means of this suction operation is sent to a recovery tank 68. The recovered liquid may be discarded or it may be reused.

### Description of Control System

FIG. 6 is a principal block diagram showing the system configuration of the inkjet recording apparatus 10. The inkjet recording apparatus 10 includes a communication interface 70, a system controller 72, an image memory 74, a motor driver 76, a heater driver 78, a print controller 80, an image buffer memory 82, a head driver 84, a light source driver 85, and the like.

The communication interface 70 is an interface (image input device) unit for receiving image data sent from a host computer 86. A serial interface such as USB (Universal Serial Bus), IEEE1394, Ethernet (registered trademark), wireless network, or a parallel interface such as a Centronics interface may be used as the communication interface 70. A buffer memory (not shown) may be mounted in this portion in order to increase the communication speed. The image data sent from the host computer 86 is received by the inkjet recording apparatus 10 through the communication interface 70, and is temporarily stored in the image memory 74.

The image memory 74 is a storage device for temporarily storing images inputted through the communication interface 70, and data is written and read to and from the image memory 74 through the system controller 72. The image memory 74 is not limited to a memory composed of semiconductor elements, and a hard disk drive or another magnetic medium may be used.

The system controller 72 is constituted of a central processing unit (CPU) and peripheral circuits thereof, and the like, and it functions as a control device for controlling the whole of the inkjet recording apparatus 10 in accordance with a prescribed program, as well as a calculation device for performing various calculations. More specifically, the system controller 72 controls the various sections, such as the communication interface 70, image memory 74, motor driver 76, heater driver 78, and the like, as well as controlling communications with the host computer 86 and writing and reading to and from the image memory 74, and it also generates control signals for controlling other motor 88 and heater 89 of the conveyance system.

Here, the motor 88 includes a motor which applies a motive force to the spanning rollers 18 described in FIG. 1, a motor which applies a motive force to the pair of media conveyance rollers 26, or a motor for adjusting the nip pressure between the opposition roller 19 and the transfer heating roller 33 in the transfer unit 28, and the like.

Moreover, the heater 89 shown in FIG. 6 includes, for example, the heater 32 inside the transfer heating roller 33 shown in FIG. 1, a heater for adjusting the temperature inside the head 50, and the like.

The program storage unit 90 shown in FIG. 6 stores various programs executed by the CPU of the system controller 72 and various data required for control procedures, and it reads out and executes programs in accordance with instructions from the system controller 72. The program storage unit 90 may be a non-rewriteable storage device such as a ROM, or it may be a rewriteable storage device, such as an EEPROM. The image memory 74 is used as a temporary storage region for the image data, and it is also used as a program development region and a calculation work region for the CPU.

The motor driver (drive circuit) 76 drives the motor 88 in accordance with commands from the system controller 72. The heater driver (drive circuit) 78 drives the heater 89 in accordance with commands from the system controller 72.

The print controller 80 has a signal processing function for performing various tasks, compensations, and other types of processing for generating print control signals from the image data stored in the image memory 74 in accordance with commands from the system controller 72 so as to supply the generated print data (dot data) to the head driver 84. Prescribed signal processing is carried out in the print controller 80, and the ejection amount and the ejection timing of the ink droplets from the respective print heads 50 are controlled via the head driver 84, on the basis of the print data. By this means, prescribed dot size and dot positions can be achieved.

The print controller 80 is provided with the image buffer memory 82; and image data, parameters, and other data are temporarily stored in the image buffer memory 82 when image data is processed in the print controller 80. Also possible is an aspect in which the print controller 80 and the system controller 72 are integrated to form a single processor.

The head driver 84 drives the actuators 58 of the heads of the respective colors 12C, 12M, 12Y and 12K on the basis of print data supplied from the print controller 80. The head driver 84 can be provided with a feedback control system for maintaining constant drive conditions for the print heads.

To give a general description of the sequence of processing from image input to print output, image data to be printed (original image data) is input from an external source via a communication interface 70, and is accumulated in the image memory 74. At this stage, RGB image data is stored in the image memory 74, for example.

In this inkjet recording apparatus 10, an image which appears to have continuous tonal graduations to the human eye is formed by changing the droplet ejection density and the dot size of fine dots created by ink (coloring material), and therefore, it is necessary to convert the input digital image into a dot pattern which reproduces the tonal graduations of the image (namely, the light and shade toning of the image) as faithfully as possible. Therefore, original image data (RGB data) stored in the image memory 74 is sent to the print controller 80 through the system controller 72, and is converted to the dot data for each ink color by a half-toning technique, using dithering, error diffusion, or the like, in the print controller 80.

In other words, the print controller 80 performs processing for converting the input RGB image data into dot data for the four colors of K, C, M and Y. The dot data generated by the print controller 80 in this way is stored in the image buffer memory 82.

The head driver 84 outputs drive signals for driving the actuators 58 corresponding to the respective nozzles 51 of the print head 50, on the basis of the dot data of the respective colors supplied from the print controller 80 (in other words, the ink dot data stored in the image buffer memory 82). In other words, the combination of the print controller 80 and the head driver 84 corresponds to the drive control device of the head 50. A feedback control system for maintaining uniform driving conditions in the head may also be incorporated into the head driver 84.

By supplying the drive signals output by the head driver 84 to the print head 50, ink is ejected from the corresponding nozzles 51. By controlling ink ejection from the heads 50 in synchronization with the conveyance speed of the intermediate transfer body 16, an image is formed on the intermediate transfer body 16.

As described above, the ejection volume and the ejection timing of the liquid droplets from the head 50 are controlled, on the basis of the dot data generated by implementing prescribed signal processing in the print controller 80. By this means, prescribed dot sizes and dot positions can be achieved.

Furthermore, the print controller 80 controls the ultraviolet light source 22 via the light source driver 85. In other words, the light source driver 85 controls the on/off switching, the irradiation amount, the irradiation time, and the like, of the ultraviolet light source 22, in conjunction with the control of the conveyance of the intermediate transfer body 16, on the basis of control signals sent from the print controller 80 to the light source driver 85.

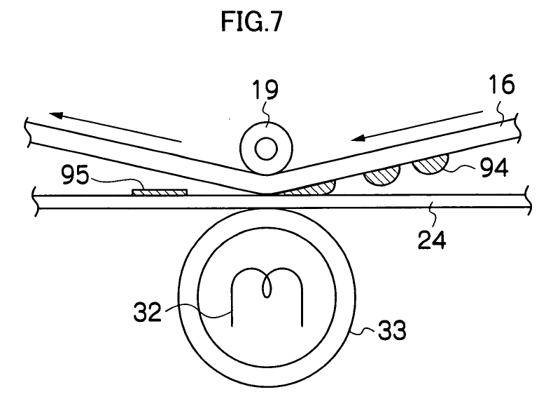

FIG. 7 is an enlarged schematic drawing of the transfer unit 28 in the inkjet recording apparatus 10 according to the present embodiment. As shown in FIG. 7, cured ink (polymerizable compound) 94 which is fixed provisionally on the intermediate transfer body 16 can be subjected to plastic deformation when heated with the transfer heating roller 33 to a temperature equal to or higher than the softening point of the cured ink 94. In this state, the intermediate transfer body 16 and the recording medium 24 are interposed between the transfer heating roller 33 and the opposition roller 19, the cured ink 94 makes contact with the recording medium 24, as well as being crushed, and ink dots 95 are transferred to the recording medium 24. Since the ink dots 95 transferred to the recording medium 24 are crushed and spread, then they have good adhesiveness with respect to the recording medium 24 and the pile height is also reduced.

### Description of Ink

Next, the ink set used in the inkjet recording apparatus according to the present embodiment is described in detail below. The inkjet recording apparatus according to the present embodiment uses an ink set including inks of respective colors, each of which contains a polymerization initiator, a polymerizable compound, and a coloring material (colorant). In particular, in the present embodiment, a completely curable type of ink is used which contains no water (non-polymerizable solvent component).

### Polymerizable Compound

The polymerizable compound in the present invention has a curing function by generating a polymerization or bridging reaction by means of initiators, such as radicals generated from the polymerization initiator, or the like, described below.

The polymerizable compound used in the present invention may be a commonly known polymerizable compound using a radical polymerization reaction, a cationic polymerization reaction, a dimerization reaction, or the like (below, these are referred to jointly as “polymerizable material”).

The polymerizable compound used in the present invention is not limited to a particular compound, provided that the polymerizable compound is cured by producing a polymerization reaction due to application of energy of some kind, and it is possible to use monomer, oligomer or polymer species. However, it is particularly desirable to use a commonly known polymerizable monomer, such as a cationically polymerizable monomer or a radically polymerizable monomer, which generates a polymerization reaction by means of initiators generated from a polymerization initiator, which is added as desired.

It is also possible to use one or more of polymerizable compounds for the purpose of adjusting the reaction speed, the ink properties and the properties of the cured film, and the like. A monofunctional compound is preferably used for the polymerizable compound, and the polymerizable compound may contain a multifunctional compound of not greater than I % at a maximum.

### Cationically Polymerizable Monomer

Possible examples of a light-induced cationically polymerizable monomer usable as the polymerizable compound in the present invention are an epoxy compound, a vinyl ether compound, an oxetane compound, or the like, as described in Japanese Patent Application Publication No. 6-9714, Japanese Patent Application Publication No. 2001-31892, Japanese Patent Application Publication No. 2001-40068, Japanese Patent Application Publication No. 2001-55507, Japanese Patent Application Publication No. 2001-310938, Japanese Patent Application Publication No. 2001-310937, Japanese Patent Application Publication No. 2001-220526, and the like.

Possible examples of the epoxy compound are: an aromatic epoxide, an alicyclic epoxide, and the like.

As examples of a monofunctional epoxy compound usable in the present invention, it is possible to cite: phenyl glycidyl ether, p-tert-butyl phenyl glycidyl ether, butyl glycidyl ether, 2-ethyl hexyl glycidyl ether, allyl glycidyl ether, 1,2-butylene oxide, 1,3-butadiene monoxide, 1,2-epoxide decane, epichlorohydrin, 1,2-epoxydecane, styrene oxide, cyclohexane oxide, 3-methacryloyl oxymethyl cyclohexane oxide, 3-acryloyl oxymethyl cyclohexane oxide, 3-vinyl cyclohexene oxide, and the like.

As examples of a monofunctional vinyl ether usable in the present invention, it is possible to cite: methyl vinyl ether, ethyl vinyl ether, propyl vinyl ether, n-butyl vinyl ether, t-butyl vinyl ether, 2-ethyl hexyl vinyl ether, n-nonyl vinyl ether, lauryl vinyl ether, cyclohexyl vinyl ether, cyclohexyl methyl vinyl ether, 4-methyl cyclohexyl methyl vinyl ether, benzyl vinyl ether, dicyclopentenyl vinyl ether, 2-dicyclopentenoxy ethyl vinyl ether, methoxyethyl vinyl ether, ethoxyethyl vinyl ether, butoxyethyl vinyl ether, methoxyethoxy ethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethyl cyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, phenoxypolyethylene glycol vinyl ether, and the like.

The oxetane compound used in the present invention includes a compound containing an oxetane ring, and a commonly known oxetane compound, such as those described in Japanese Patent Application Publication No. 2001-220526, Japanese Patent Application Publication No. 2001-310937, Japanese Patent Application Publication No. 2003-341217, and the like, may be used.

Desirably, the compound having an oxetane ring which is contained in the ink composition used for carrying out the present invention is a compound having 1 to 4 oxetane rings in its structure. By using a compound of this kind, the viscosity of the ink composition can be maintained easily within a range that is suitable for handling, as well as obtaining good adhesiveness of the ink to the recording medium after curing.

As examples of a monofunctional oxetane compound usable in the present invention, it is possible to cite: 3-ethyl-3-hydroxymethyl oxetane, 3-(meta)allyloxymethyl-3-ethyloxetane, (3-ethyl-3-oxetanyl methoxy) methyl benzene, 4-fluoro-[1-(3-ethyl-3-oxetanyl methoxy)methyl]benzene, 4-methoxy-[1-(3-ethyl-3-oxetanyl methoxy)methyl]benzene, [1-(3-ethyl-3-oxetanyl methoxy)ethyl]phenyl ether, isobutoxymethyl(3-ethyl-3-oxetanyl methyl)ether, isobornyl oxyethyl(3-ethyl-3-oxetanyl methyl)ether, isobornyl(3-ethyl-3-oxetanyl methyl)ether, 2-ethyl hexyl(3-ethyl-3-oxetanyl methyl)ether, ethyl diethylene glycol(3-ethyl-3-oxetanyl methyl)ether, dicyclopentadiene(3-ethyl-3-oxetanyl methyl)ether, dicyclopentenyl oxyethyl(3-ethyl-3-oxetanyl methyl)ether, dicyclopentenyl(3-ethyl-3-oxetanyl methyl)ether, tetrahydrofurfuryl(3-ethyl-3-oxetanyl methyl)ether, tetrabromophenyl(3-ethyl-3-oxetanyl methyl)ether, 2-tetrabromophenoxyethyl(3-ethyl-3-oxetanyl methyl)ether, tribromophenyl(3-ethyl-3-oxetanyl methyl)ether, 2-tribromophenoxyethyl(3-ethyl-3-oxetanyl methyl)ether, 2-hydroxyethyl(3-ethyl-3-oxetanyl methyl)ether, 2-hydroxypropyl(3-ethyl-3-oxetanyl methyl)ether, butoxyethyl(3-ethyl-3-oxetanyl methyl)ether, pentachlorophenyl(3-ethyl-3-oxetanyl methyl)ether, pentabromophenyl(3-ethyl-3-oxetanyl methyl)ether, bornyl(3-ethyl-3-oxetanyl methyl)ether, or the like.

For the compound having oxetane rings of this kind, it is suitable to use the compounds described in detail in paragraphs (0021) to (0084) of Japanese Patent Application Publication No. 2003-341217.

Of the oxetane compounds used in the present invention, it is desirable to use a compound having one to two oxetane rings from the viewpoint of the viscosity and the adhesiveness of the ink composition.

In the ink composition used for carrying out the present invention, it is possible to use only one type of these polymerizable compounds or two or more types of these polymerizable compounds. From the viewpoint of effectively suppressing contraction in curing of the ink, it is desirable to combine the use of at least one type of oxetane compound, and at least one type of compound selected from epoxy compounds and vinyl ether compounds.

### Radically Polymerizable Monomer

Various commonly known radically polymerizable monomers which produce a polymerization reaction due to initiators generated from a photo-radical initiator can be used preferably as a polymerizable compound in the present invention.

Examples of the radically polymerizable monomer usable in the present invention are: a (meth)acrylate, a (meth)acrylamide, an aromatic vinyl, or the like. In the present specification, the term “(meth)acrylate” indicates “acrylate” and/or “methacrylate”, and the term “(meth)acryl” indicates “acryl” and/or “methacryl”.

Examples of (meth)acrylates usable in the present invention include the following, for instance.

Examples of a monofunctional(meth)acrylate are: a hexyl(meth)acrylate, 2-ethyl hexyl(meth)acrylate, tert-octyl(meth)acrylate, isoamyl(meth)acrylate, decyl(meth)acrylate, isodecyl(meth)acrylate, stearyl(meth)acrylate, isostearyl(meth)acrylate, cyclohexyl(meth)acrylate, 4-n-butyl cyclohexyl(meth)acrylate, bornyl(meth)acrylate, isobornyl(meth)acrylate, benzyl(meth)acrylate, 2-ethyhexyl diglycol(meth)acrylate, butoxyethyl(meth)acrylate, 2-chloroethyl(meth)acrylate, 4-bromobutyl(meth)acrylate, cyanoethyl(meth)acrylate, benzyl(meth)acrylate, butoxymethyl(meth)acrylate, 3-methoxybutyl(meth)acrylate, alkoxymethyl(meth)acrylate, alkoxyethyl(meth)acrylate, 2-(2-methoxyethoxy)ethyl(meth)acrylate, 2-(2-butoxyethoxy)ethyl(meth)acrylate, 2,2,2-tetrafluoroethyl(meth)acrylate, 1H,1H,2H,2H perfluorodecyl(meth)acrylate, 4-butyl phenyl(meth)acrylate, phenyl(meth)acrylate, 2,4,5-tetramethyl phenyl(meth)acrylate, 4-chlorophenyl(meth)acrylate, phenoxymethyl(meth)acrylate, phenoxyethyl(meth)acrylate, glycidyl(meth)acrylate, glycidyl oxybutyl(meth)acrylate, glycidyl oxyethyl(meth)acrylate, glycidyl oxypropyl(meth)acrylate, tetrahydrofurfuryl(meth)acrylate, hydroxyalkyl(meth)acrylate, 2-hydroxyethyl(meth)acrylate, 3-hydroxypropyl(meth)acrylate, 2-hydroxypropyl(meth)acrylate, 2-hydroxybutyl(meth)acrylate, 4-hydroxybutyl(meth)acrylate, 3-hydroxypropyl(meth)acrylate, dimethyl aminoethyl(meth)acrylate, diethyl aminoethyl(meth)acrylate, dimethyl aminopropyl(meth)acrylate, diethyl aminopropyl(meth)acrylate, trimethoxysilyl propyl(meth)acrylate, trimethylsilyl propyl(meth)acrylate, polyethylene oxide monomethyl ether(meth)acrylate, oligo-ethylene oxide monomethyl ether(meth)acrylate, polyethylene oxide(meth)acrylate, oligo-ethylene oxide(meth)acrylate, oligo-ethylene oxide monoalkyl ether(meth)acrylate, polyethylene oxide monoalkyl ether(meth)acrylate, dipropylene glycol(meth)acrylate, polypropylene oxide monoalkyl ether(meth)acrylate, oligo-propylene oxide monoalkyl ether(meth)acrylate, 2-methacryloyloxy ethyl succinate, 2-methacryloyloxy hexahydro phthalate, 2-methacryloyloxy ethyl 2-hydroxypropyl phthalate, butoxy diethylene glycol(meth)acrylate, trifluoroethyl(meth)acrylate, perfluoro octylethyl(meth)acrylate, 2-hydroxy-3-phenoxy propyl(meth)acrylate, EO-modified phenol(meth)acrylate, EO-modified cresol(meth)acrylate, EO-modified nonyl phenol(meth)acrylate, PO-modified nonyl phenol(meth)acrylate, EO-modified 2-ethyl hexyl(meth)acrylate, and the like.

Examples of a (meth)acrylamide usable in the present invention include: (meth)acrylamide, N-methyl(meth)acrylamide, N-ethyl(meth)acrylamide, N-propyl(meth)acrylamide, N-n-butyl(meth)acrylamide, N-t-butyl(meth)acrylamide, N-butoxy methyl(meth)acrylamide, N-isopropyl(meth)acrylamide, N-methylol(meth)acrylamide, N,N-dimethyl(meth)acrylamide, N,N-diethyl(meth)acrylamide, or (meth)acryloyl morphine.

Specific examples of aromatic vinyls usable in the present invention are: styrene, methyl styrene, dimethyl styrene, trimethyl styrene, ethyl styrene, isopropyl styrene, chloromethyl styrene, methoxy styrene, acetoxy styrene, chlorostyrene, dichlorostyrene, bromostyrene, methyl ester of vinyl benzoic acid, 3-methyl styrene, 4-methyl styrene, 3-ethyl styrene, 4-ethyl styrene, 3-propyl styrene, 4-propyl styrene, 3-butyl styrene, 4-butyl styrene, 3-hexyl styrene, 4-hexyl styrene, 3-octyl styrene, 4-octyl styrene, 3-(2-ethyl hexyl)styrene, 4-(2-ethyl hexyl)styrene, allyl styrene, isopropenyl styrene, butenyl styrene, octenyl styrene, 4-t-butoxycarbonyl styrene, 4-methoxystyrene, or 4-t-butoxystyrene.

Examples of radically polymerizable monomers usable in the present invention include: vinyl esters (vinyl acetate, vinyl propionate, vinyl versatate, or the like), allyl esters (allyl acetate, or the like), a halogen-containing monomer (vinylidene chloride, vinyl chloride, or the like), a vinyl ether (methyl vinyl ether, butyl vinyl ether, hexyl vinyl ether, methoxy vinyl ether, 2-ethyl hexyl vinyl ether, methoxyethyl vinyl ether, cyclohexyl vinyl ether, chloroethyl vinyl ether, or the like), a vinyl cyanide((meth)acrylonitrile, or the like), or an olefin (ethylene, propylene, or the like).

Of these, from the viewpoint of curing speed, it is desirable to use a (meth)acrylate or a (meth)acrylamide as the radically polymerizable monomer in the present invention.

It is possible either to use one type of polymerizable material only, or to use two or more types of polymerizable material.

The content of the polymerizable material in the first liquid, or if necessary, in the second liquid, is desirably in the range of 50 wt % to 99.6 wt % with respect to the total solid content (weight) of the respective droplets, and more desirably, it is in the range of 70 wt % to 99.0 wt % and even more desirably, in the range of 80 wt % to 99.0 wt %, with respect to same.

Furthermore, desirably, the content of the polymerizable material in the droplets falls within the range of 20 wt % to 98 wt %, more desirably, the range of 40 wt % to 95 wt %, and especially desirably, the range of 50 wt % to 90 wt %, with respect to the total weight of the droplets.

### Polymerization Initiator

It is possible to use one or more type of polymerization initiator in the ink that can be used in the present invention. The polymerization initiator produces a substance such as a radical that initiates the chain reaction, for example, when the polymerization initiator is supplied with an active light, heat, or combination of these. The production of this substance results in the initiation and acceleration of polymerization of the above-described polymerizable compound, and the polymerizable compound is consequently cured.

It is desirable to include a polymerization initiator which generates radical polymerization or cationic polymerization as the polymerization mode, and it is especially desirable to include a photo-polymerization initiator.

A polymerization initiator may be a compound which generates at least one of a radical, an acid and/or a base, by producing a chemical change due to the action of light or mutual interaction with the electronically excited state of a sensitizing dye. Of these, a photo-activated radical generating agent or a photo-activated acid generating agent is desirable, from the viewpoint of enabling polymerization to be started by means of the simple device of exposure to light.

As a photo-polymerization initiator, it is possible to use a material selected appropriately to have sensitivity with respect to the radiated activating light rays, for example, ultraviolet light having the wavelength of 400 nm to 200 nm, far ultraviolet light, g rays, h rays, i rays, KrF excimer laser light, ArF excimer laser light, an electron beam, X rays, a molecular beam, an ion beam, or the like.

From the viewpoint of cost and safety, it is preferable to adopt a mode where the polymerizable compound of radical-polymerization type is cured by irradiation of an electron beam, since no initiator is required in this mode.

Any photo-polymerization initiator that is commonly known by a person skilled in the art may be used, without any particular restrictions, and many specific examples of photo-polymerization initiators are described, for example, in: Bruce M. Monroe, et. al., Chemical Review, 93, 435 (1993); R. S. Davidson, Journal of Photochemistry and Biology A: Chemistry, 73.81 (1993); J. P. Faussier, “Photoinitiated Polymerization-Theory and Applications”: Rapra Review, Vol. 9, Report, Rapra Technology (1998); and M. Tsunooka et al., Prog. Polym. Sci., 21.1 (1996). Furthermore, many chemically sensitized photoresists and compounds used in optical cationic polymerization are disclosed in “Organic Materials for Imaging,” (edited by Japanese Research Association for Organic Electronics Materials, published by Bunshin (1993), pp. 187 to 192). Moreover, also known are a group of compounds which produce oxidative or reductive bond cleavage due to interaction with the electronically excited state of a sensitizing dye, such as those described, for example, in F. D. Saeva, Topics in Current Chemistry, 156,59 (1990), G. G Maslak, Topics in Current Chemistry, 168,1 (1993), H. B. Shuster, et al., JACS, 112, 6329 (1990), and I. D. F. Eaton, et al., JACS, 102, 3298 (1980).

Desirable examples of a photo-polymerization initiator are: (a) aromatic ketones; (b) aromatic onium salts; (c) organic peroxides; (d) hexaaryl diimidazole compounds; (e) ketoxime ester compounds; (f) borate compounds; (g) azinium compounds; (h) metallocene compounds; (i) activated ester compounds; (j) compounds having a carbon-halogen bond; and the like.

Desirable examples of the (a) aromatic ketones are, for example, compounds having a benzophenone skeleton or thioxanthone skeleton, such as those described in “Radiation Curing in Polymer Science and Technology,” J. P. Fouassier and J. F. Rabek (1993), pp. 77 to 117. As more desirable examples of the (a) aromatic ketones, it is possible to cite: an α-thiobenzophenone compound as described in Japanese Patent Publication No. 47-6416; a benzoin ether compound as described in Japanese Patent Publication No. 47-3981; an α-substituted benzoin compound as described in Japanese Patent Publication No. 47-22326; a benzoin derivative as described in Japanese Patent Publication No. 47-23664; an aroyl phosphonic acid ester as described in Japanese Patent Application Publication No. 57-30704; a dialkoxy benzophenone as described in Japanese Patent Publication No. 60-26483; a benzoin ether as described in Japanese Patent Publication No. 60-26403 and Japanese Patent Application Publication No. 62-81345; an α-aminobenzophenone as described in Japanese Patent Publication No. 1-34242, U.S. Pat. No. 4,318,791, and European Patent No. 0284561 A1; a p-di(dimethyl aminobenzoyl)benzene as described in Japanese Patent Application Publication No. 2-211452; a thio-substituted aromatic ketone as described in Japanese Patent Application Publication No. 61-194062; an acyl phosphine sulfide as described in Japanese Patent Publication No. 2-9597; an acyl phosphine as described in Japanese Patent Publication No. 2-9596; a thioxanthone as described in Japanese Patent Application No. 63-61950; a cumarine as described in Japanese Patent Application No. 59-42864; and the like.

The (b) aromatic omium salts include aromatic omium salts of elements of groups V, VI and VII of the periodic table, and more specifically, N, P, As, Sb, Bi, O, S, Se, Te or I. For example, it is suitable to use: an iodonium salt as described in European Patent No. 104143, the specification of U.S. Pat. No. 4,837,124, Japanese Patent Application Publication No. 2-150848, and Japanese Patent Application Publication No. 2-96514; a sulfonium salt as described in the respective specifications of European Patent No. 370693, European Patent No. 233567, European Patent No. 297443, European Patent No. 297442, European Patent No. 279210, European Patent No. 422570, U.S. Pat. No. 3,902,144, U.S. Pat. No. 4,933,377, U.S. Pat. No. 4,760,013, U.S. Pat. No. 4,734,444 and U.S. Pat. No. 2,833,827; a diazonium salt (such as a benzene diazonium which may contain a substituted group); a resin of a diazonium salt (such as a formaldehyde resin of diazo diphenylamine); an N-alkoxy pyrridium salt (such as those described in the specification of U.S. Pat. No. 4,743,528, Japanese Patent Application Publication No. 63-138345, Japanese Patent Application Publication No. 63-142345, Japanese Patent Application Publication No. 63-142346 and Japanese Patent Publication No. 46-42363, and more specifically, 1-methoxy-4-phenyl pyrridium tetrafluoroborate, for instance); or a compound such as those described in Japanese Patent Publication No. 52-147277, Japanese Patent Publication No. 52-14278 and Japanese Patent Publication No. 52-14279. These salts may generate radicals or acids as the active species.

The (c) “organic peroxides” described above include almost all organic compounds having one or more oxygen-oxygen body in the molecule, but desirable examples of same are peroxide esters, such as: 3,3′,4,4′-tetra-(t-butyl peroxycarbonyl)benzophenone, 3,3′,4,4′-tetra-(t-amyl peroxycarbonyl)benzophenone, 3,3′,4,4′-tetra-(t-hexyl peroxycarbonyl)benzophenone, 3,3′,4,4′-tetra-(t-octyl peroxycarbonyl)benzophenone, 3,3′,4,4′-tetra-(cumyl peroxycarbonyl)benzophenone, 3,3′,4,4′-tetra-(p-iso-propyl cumyl peroxycarbonyl)benzophenone, di-t-butyl di-peroxy isophthalate, and the like.

As examples of the (d) hexaaryl diimidazoles mentioned above, it is possible to cite a lophine dimer as described in Japanese Patent Publication No. 45-37377 and Japanese Patent Publication No. 44-86516, such as: 2,2′-bis(o-chlorophenyl)-4,4′,5,5′-tetraphenyl biimidazole; 2,2′-bis(o-bromophenyl)-4,4′,5,5′-tetraphenyl biimidazole; 2,2′-bis(o,p-dichloro-phenyl)-4,4′,5,5′-tetraphenyl biimidazole; 2,2′-bis(o-chlorophenyl)-4,4′,5,5′-tetra-(m-methoxyphenyl)biimidazole; 2,2′-bis(o,o′-dichloro-phenyl)-4,4′,5,5′-tetraphenyl biimidazole; 2,2′-bis(o-nitrophenyl)-4,4′,5,5′-tetraphenyl biimidazole; 2,2′-bis(o-methyl-phenyl)-4,4′,5,5′-tetraphenyl biimidazole; and 2,2′-bis(o-trifluoro-phenyl)-4,4′,5,5′-tetraphenyl biimidazole, and the like.

As examples of the (e) ketoxium esters mentioned above, it is possible to cite, for example, 3-benzoyloxy-iminobutane-2-one, 3-acetoxy-iminobutane-2-one, 3-propionyloxy-iminobutane-2-one, 2-acetoxy-iminopentane-3-one, 2-acetoxyimino-1-phenylpropane-1-one, 2-benzoyloxyimino-1-phenylpropane-1-one, 3-p-toluene sulfonyloxy iminobutane-2-one, and 2-ethoxycarbonyl oxyimino-1-phenylpropane-1-one, and the like.

Possible examples of the (f) borate compounds mentioned above are the compounds described in U.S. Pat. No. 3,567,453, U.S. Pat. No. 4,343,891, European Patent No. 109772 and European Patent No. 109773.

As examples of the (g) azinium compounds mentioned above, it is possible to cite a group of compounds having N—O bonds as described in Japanese Patent Application Publication No. 63-138345, Japanese Patent Application Publication No. 63-142345, Japanese Patent Application Publication No. 63-142346, Japanese Patent Application Publication No. 63-143537, and Japanese Patent Publication No. 46-42363.

As examples of the (h) metallocene compounds described above, it is possible to cite a titanocene compound as described in Japanese Patent Application Publication No. 59-152396, Japanese Patent Application Publication No. 61-151197, Japanese Patent Application Publication No. 63-41484, Japanese Patent Application Publication No. 2-249, or Japanese Patent Application Publication No. 2-4705, or an iron-arene complex as described in Japanese Patent Application Publication No. 1-304453 or Japanese Patent Application Publication No. 1-152109.

Specific examples of the aforementioned titanocene compound are: di-cyclopentadienyl-Ti-di-chloride; di-cyclopentadienyl-Ti-bis-phenyl; di-cyclopentadienyl-Ti-bis-2,3,4,5,6-pentafluorophen-1-yl; di-cyclopentadienyl-Ti-bis-2,3,5,6tetrafluorophen-1-yl; di-cyclopentadienyl-Ti-bis-2,4,6-trifluorophen-1-yl; di-cyclopentadienyl-Ti-bis-2,6-di-fluorophen-1-yl; di-cyclopentadienyl-Ti-bis-2,4-di-fluorophen-1-yl; di-methyl-cyclopentadienyl-Ti-bis-2,3,4,5,6-pentafluorophen-1-yl; di-methyl-cyclopentadienyl-Ti-bis-2,3,5,6-tetrafluorophen-1-yl; di-methyl-cyclopentadienyl-Ti-bis-2,4-difluorophen-1-yl; bis(cyclopentadienyl)-bis(2,6-difluoro-3-(pyr-1-yl)phenyl)titanium; bis(cyclopentadienyl)bis[2,6-difluoro-3-(methyl-sulfonamide)phenyl]titanium; and bis(cyclopentadienyl)bis[2,6-difluoro-3-(N-butyl biaroyl-amino)phenyl]titanium, and the like.

Examples of the (i) active ester compounds described above are: a nitrobenzyl ester compound as described in the specifications of European Patent No. 0290750, European Patent No. 046083, European Patent No. 156153, European Patent No. 271851 and European Patent No. 0388343, the specifications of U.S. Pat. No. 3,901,710 and U.S. Pat. No. 4,181,531, Japanese Patent Application Publication No. 60-198538, and Japanese Patent Application Publication No. 53-133022; an iminosulfonate compound as described in the specifications of European Patent No. 0199672, European Patent No. 84515, European Patent No. 199672, European Patent No. 044115, and European Patent No. 0101122, the specifications of U.S. Pat. No. 4,618,564, U.S. Pat. No. 4,371,605, and U.S. Pat. No. 4,431,774, Japanese Patent Application Publication No. 64-18143, Japanese Patent Application Publication No. 2-245756, and Japanese Patent Application Publication No. 4-365048; and a compound as described in Japanese Patent Publication No. 62-6223, Japanese Patent Publication No. 63-14340 and Japanese Patent Application Publication No. 59-174831.

Desirable examples of the (j) compounds containing an oxygen halogen bond mentioned above are, for instance: a compound as described by Wakabayashi, et al., in Bull. Chem. Soc. Japan, 42, 2924 (1969), a compound as described in the specification of GB Patent No. 1388492, a compound as described in Japanese Patent Application Publication No. 53-133428, a compound as described in the specification of German Patent No. 3337024, or the like. Furthermore, it is also possible to cite a compound described by F. C. Schaefer, et. al., in J. Org. Chem, 29, 1527 (1964), a compound described in Japanese Patent Application Publication No. 62-58241, a compound described in Japanese Patent Application Publication No. 5-281728, and the like. It is also possible to cite a compound described in German Patent No. 2641100, a compound described in German Patent No. 3333450, a group of compounds described in German Patent No. 3021590, or a group of compounds described in German Patent 3021599, or the like.

Desirable specific examples of the compounds expressed by (a) to 0) above include the following.

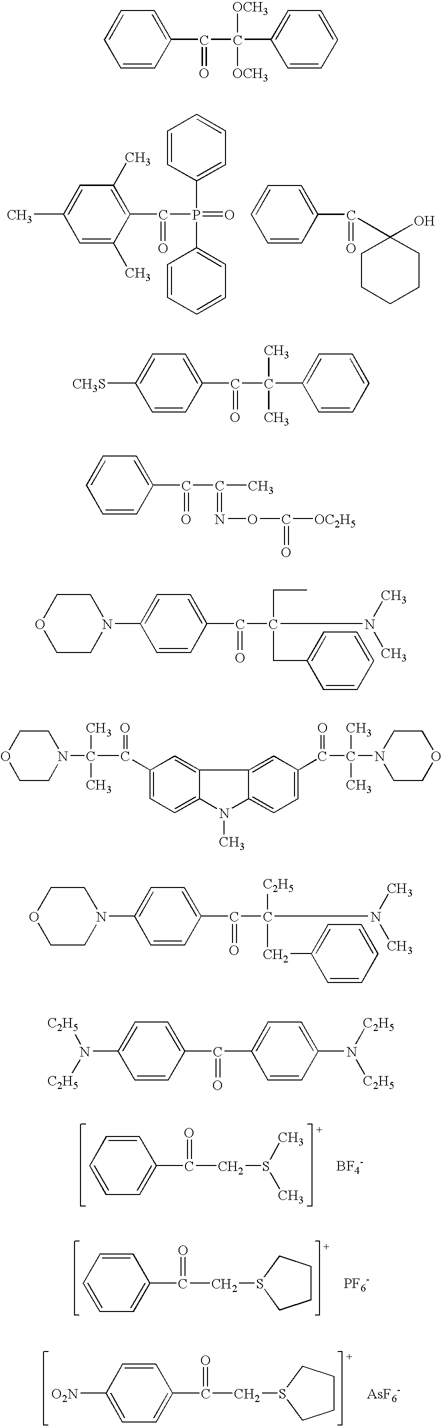

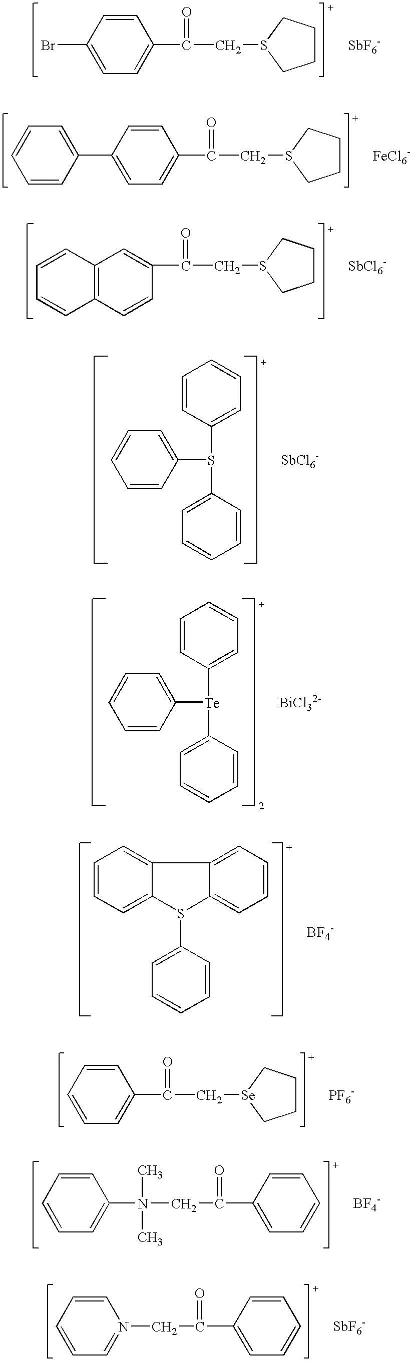

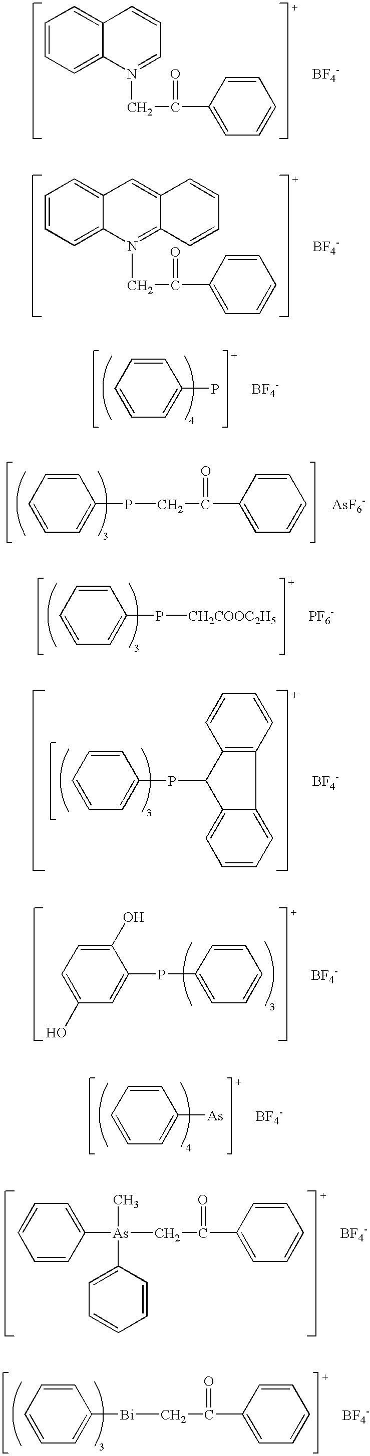

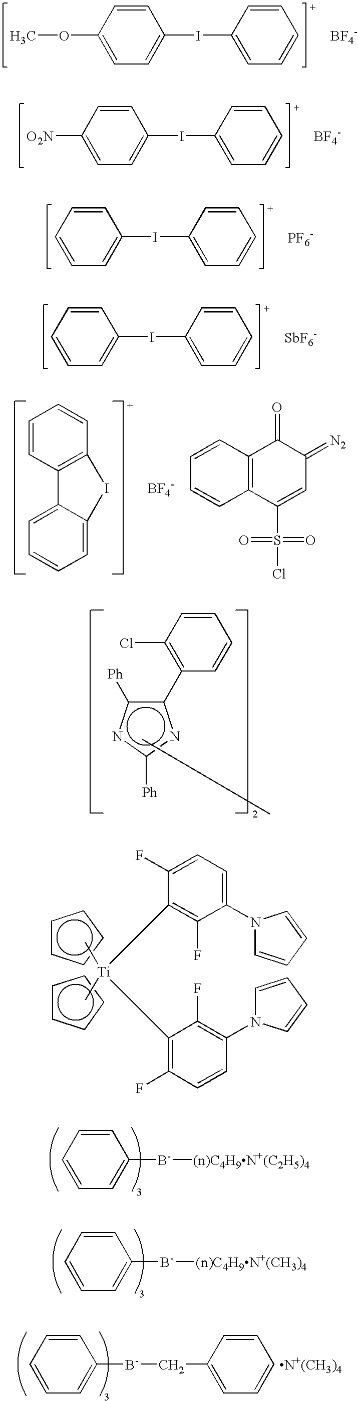

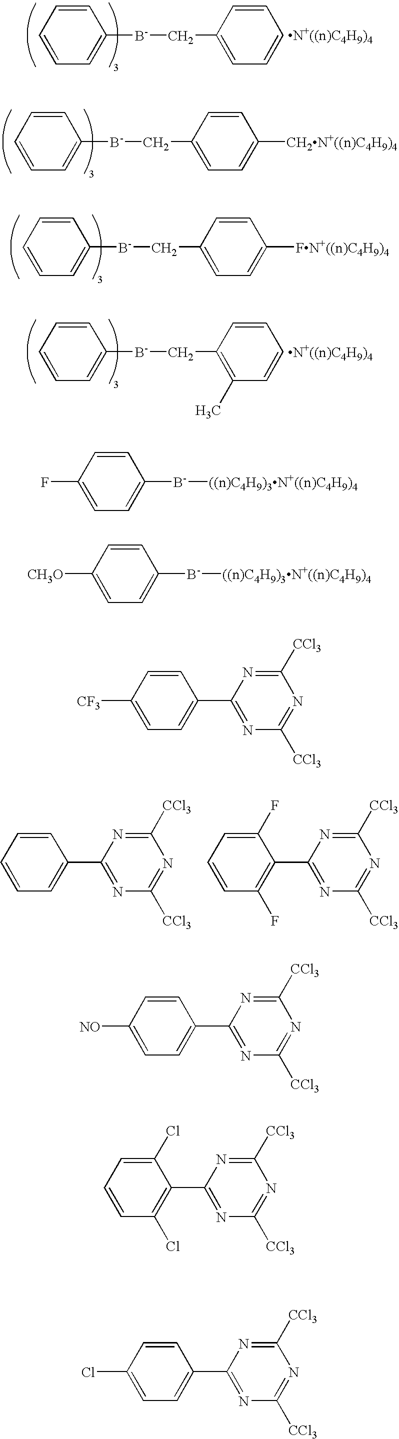

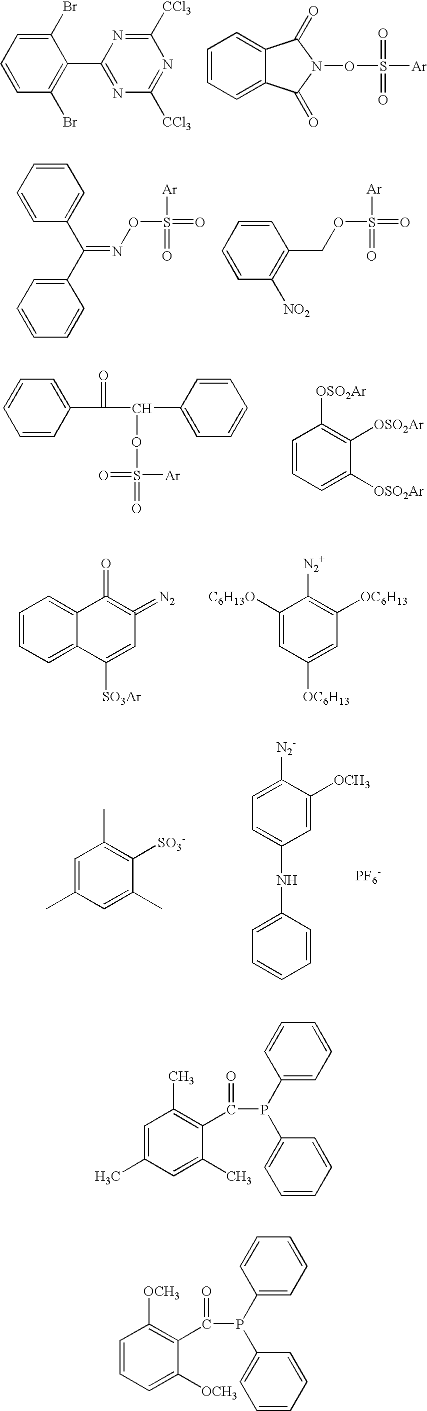

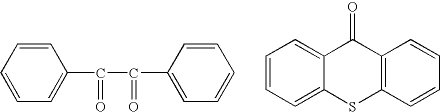

Desirably, the polymerization initiator has excellent sensitivity. Moreover, from the viewpoint of storage stability, it is not desirable to use a polymerization initiator which produces pyrolysis at a temperature of 80° C. or below, and therefore, preferably, a polymerization initiator which does not produce pyrolysis at temperatures up to 80° C. is chosen.

For the polymerization initiator, it is possible to use one type of initiator, or a combination of two or more types of initiator. Furthermore, provided that the beneficial effects of the present invention are not impaired, it is also possible to use a commonly known sensitizing agent, conjointly, with the object of improving sensitivity.

From the viewpoint of temporal stability, curability, and curing speed, the amount of polymerization initiator contained in the second liquid B is desirably, 0.5 wt % to 20 wt %, more desirably, 1 wt % to 15 wt %, and especially desirably, 3 wt % to 10 wt %, with respect to the polymerizable material applied per unit surface area when the maximum volumes of the first liquid A and the second liquid B required for image formation are applied in the form of droplets on the medium. If the content of polymerization initiator is too high, then precipitation or separation occurs over time, and the strength and wear resistance of the ink after curing are impaired.

The polymerization initiator may also be contained in the first liquid A as well as in the second liquid B, and in this case, it is possible to add polymerization initiator appropriately in such a manner that the amount of the polymerization initiator falls within a range which makes it possible to maintain a desired level of storage stability for the first liquid A.

Furthermore, the polymerization initiator may also be contained in the first liquid A without being contained in the second liquid B. In this case, the content of the polymerization initiator in the first liquid is desirably 0.5 wt % to 20 wt %, and more desirably, 1 wt % to 15 wt %, with respect to the polymerizable or bridgeable compound in the first liquid A.

### Sensitizing Dye

In the present invention, a sensitizing dye may be added with the object of improving the sensitivity of the photo-polymerization initiator. As a desirable example of a sensitizing dye, it is possible to cite a dye belonging to the following group of compounds, which has an absorption wavelength in the range of 350 nm to 450 nm.

Desirable examples of a sensitizing dye are: polynuclear aromatic compounds (such as pyrene, perylene and triphenylene); xanthenes (such as fluorescein, eosine, erythrosine, rhodamine B and rose bengale); cyanines (such as thia-carbo cyanine and oxa-carbo cyanine); merocyanines (such as merocyanine and carbo merocyanine); thiazines (such as thionine, methylene blue and toluidine blue); acridine dyes (such as acridine orange, chloroflavin and acriflavine); anthraquinones (such as anthraquinone); squaliums (such as squalium); and coumarins (such as 7-diethylamino-4-methyl coumarin).

More desirable examples of a sensitizing dye are the compounds represented by the following general formulas (IX) to (XIII) below.

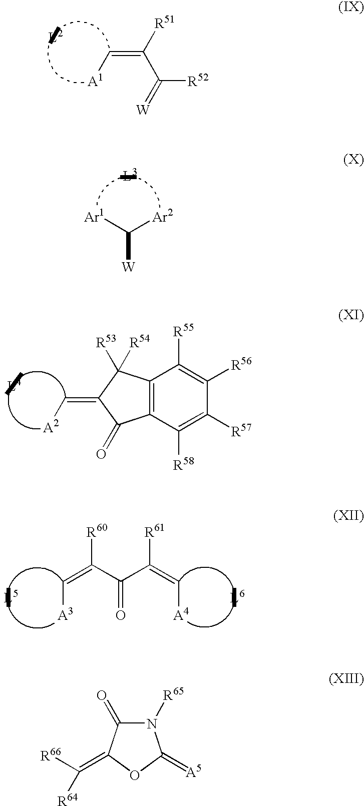

In Formula (IX), A¹ represents a sulfur atom or NR⁵⁰; R⁵⁰ represents an alkyl group or an aryl group; L² represents a non-metallic atomic group that forms a basic nucleus of the coloring material in conjunction with an adjacent Al and adjacent carbon atoms; R⁵¹ and R⁵² each represent a hydrogen atom or a monovalent non-metallic atomic group; and R⁵¹ and R⁵² may be linked to each other to form an acid nucleus of the coloring material. W represents an oxygen atom or a sulfur atom.

In Formula (X), Ar¹ and Ar² each represent an aryl group, and they are linked together by means of L³. Here, L³ represents —O— or —S—. Furthermore, W has the same meaning as that specified in general formula (IX).

In Formula (IX), A² represents a sulfur atom or NR⁵⁹, L⁴ represents a non-metallic atomic group that forms a basic nucleus of the coloring material in conjunction with an adjacent A² and carbon atoms; R⁵³, R⁵⁴, R⁵⁵, R⁵⁶, R⁵⁷ and R⁵⁸ each represent a monovalent non-metallic atomic group; and R⁵⁹ represents an alkyl group or an aryl group.

In Formula (XII), A³ and A⁴ each represent —S— or —NR⁶²— or —NR⁶³—; R⁶² and R⁶³ each represent a substituted or non-substituted alkyl group, and a substituted or non-substituted aryl group; L⁵ and L⁶ each represent a non-metallic atomic group that forms a basic nucleus of the coloring material in conjunction with the adjacent A³ and A⁴ and adjacent carbon atoms; and R⁶⁰ and R⁶¹ each represent a hydrogen atom or a monovalent non-metallic atomic group, or they may be linked together in order to form an aliphatic or aromatic ring.

In Formula (XIII), R⁶⁶ represents an aromatic ring or a hetero ring which may have a substituted group, and A⁵ represents an oxygen atom, a sulfur atom or —NR⁶⁷—. R⁶⁴, R⁶⁵ and R⁶⁷ each represent a hydrogen atom or a monovalent non-metallic atomic group; R⁶⁷ and R⁶⁴, and R⁶⁵ and R⁶⁷ may be linked with each together to form an aliphatic or aromatic ring.

Desirable specific examples of compounds represented by the general formulas (IX) to (XIII) below include the example compounds (A-1) to (A-20) listed below.

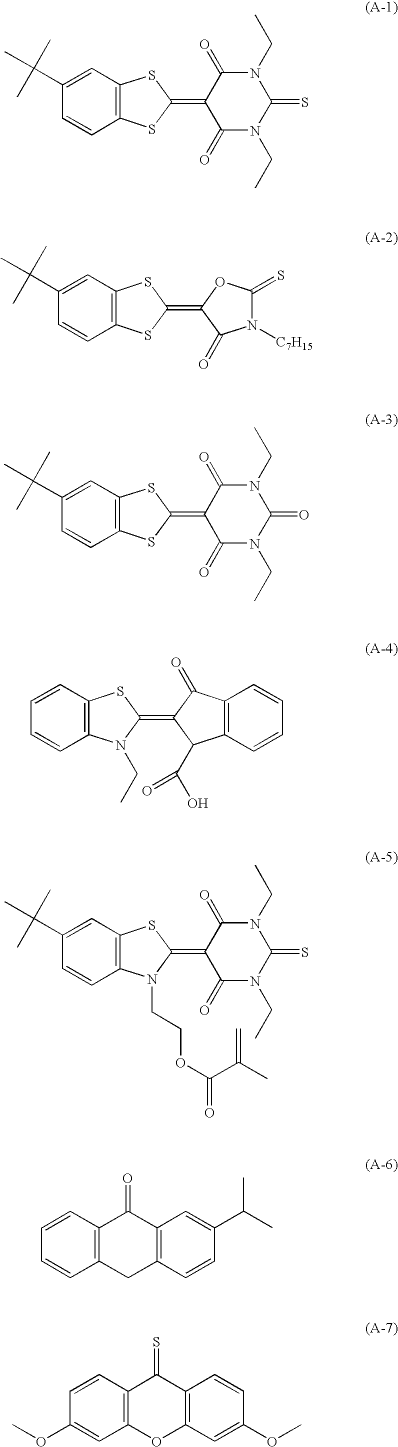

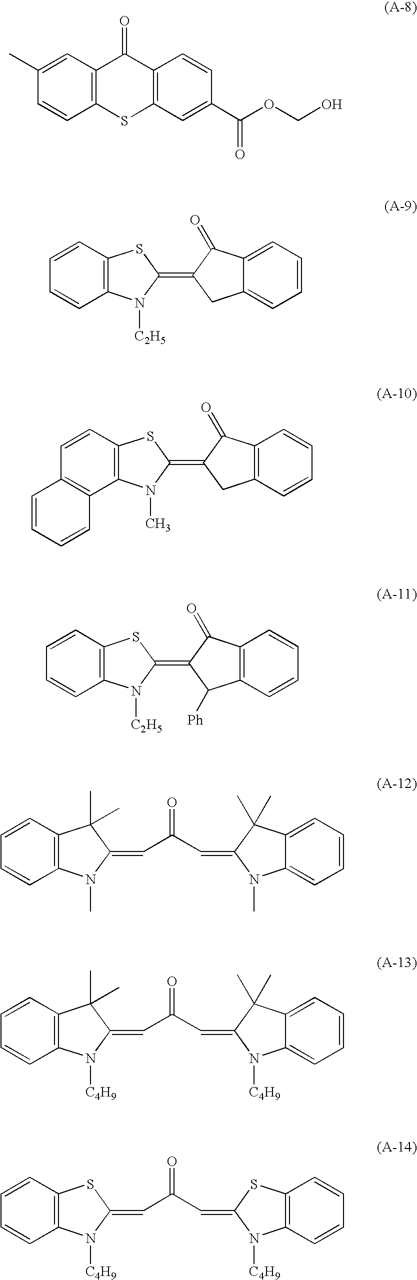

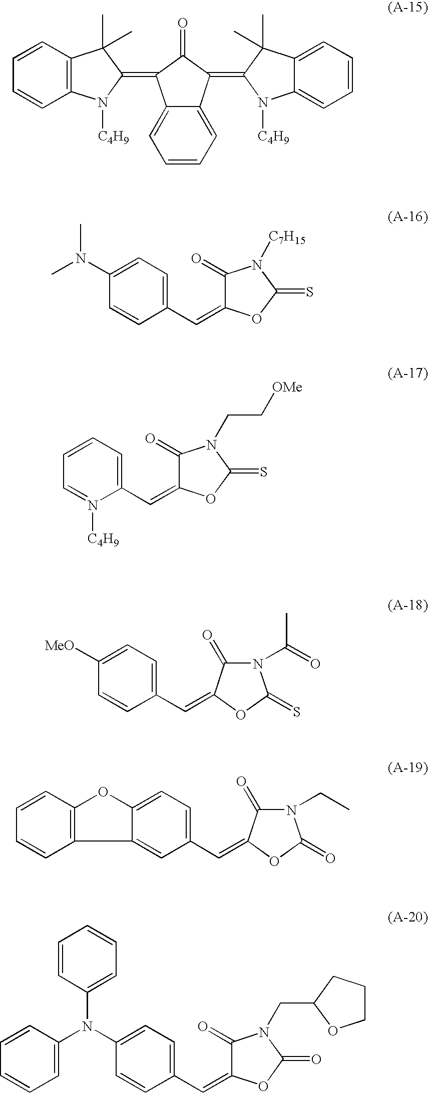

### Co-Sensitizing Agent

Moreover, it is also possible to add a co-sensitizing agent, which is a commonly known compound having the action of further enhancing sensitivity or suppressing inhibition of the polymerization reaction by oxygen.

Examples of a co-sensitizing agent include amines, such as the compounds described, for example, in M. R. Sander et. al., “Journal of Polymer Society”, Vol. 10, p. 3173 (1972), Japanese Patent Publication No. 44-20189, Japanese Patent Application Publication No. 51-82102, Japanese Patent Application Publication No. 52-134692, Japanese Patent Application Publication No. 59-138205, Japanese Patent Application Publication No. 60-84305, Japanese Patent Application Publication No. 62-18537, Japanese Patent Application Publication No. 64-33104, Research Disclosure No. 33825, and the like, and more specific examples of same are: triethanol amine, p-dimethyl amino benzoate ethyl ester, p-formyl dimethyl aniline, p-methylthio dimethyl aniline, and the like.

Other examples include thiols and sulfides, for example, a thiol compound as described in Japanese Patent Application Publication No. 53-702, Japanese Patent Publication No. 55-500806, or Japanese Patent Application Publication No. 5-142772, or a disulfide compound as described in Japanese Patent Application Publication No. 56-75643, and more specific examples are: 2-mercaptobenzothiazole, 2-meracptobenzoxazole, 2-mercaptobenzoimidazole, 2-mercapto-4(3H)-quinazoline, β-mercapto-naphthalene, and the like.

Other possible examples include amino acid compounds (for example, N-phenyl glycine), an organic metallic compound as described in Japanese Patent Publication No. 48-42965 (for example, tributyl tin acetate), a hydrogen donor as described in Japanese Patent Publication No. 55-34414, a sulfur compound as described in Japanese Patent Application Publication No. 6-308727 (for example, trithiane), a phosphorus compound as described in Japanese Patent Application Publication No. 6-250387 (diethyl phosphite, or the like), or an Si—H or Ge—H compound, or the like, as described in Japanese Patent Application Publication No. 8-65779.

### EXAMPLES

Next, the present invention is described in more detail with reference to practical examples, but the present invention is not limited to these practical examples.

### Practical Example 1

The ink liquids 101 to 106 having the compositions described below were prepared and transfer characteristics and fixing characteristics were evaluated for each of these ink liquids.

### <Ink Liquid 101 (Practical Example)>

The polymerizable compound in the ink liquid 101 is composed only of monofunctional monomer. The use of ink liquid 101 corresponds to carrying out the present invention.

The ink liquid 101 having the following composition was prepared with a beads-mill using zirconia beads. As shown in the following, the polymerizable compound contained in the ink liquid 101 is only isobornyl acrylate.
Isobornyl acrylate (NK ester A-IB made by Shin-Nakamura Chemical Co., Ltd.): 85.3 wt %
Cyan pigment PB-15:3 (Irgalite Blue GLVO manufactured by Ciba Specialty Chemicals Ltd.): 5.0 wt %
Dispersant (SOLSPERS28000 manufactured by Avecia Inkjet Ltd.): 0.7 wt %
Photopolymerization initiator (IRGACURE907 manufactured by Ciba Specialty Chemicals Ltd.): 8.7 wt %
Surfactant (Megafac F444 manufactured by Dai-Nippon Ink & Chemicals, Inc.): 0.3 wt %

### <Ink Liquid 102 (Practical Example)>

The polymerizable compound in the ink liquid 102 contains 1 wt % bifuctional monomer. The use of the ink liquid 102 corresponds to carrying out the present invention.

The ink liquid 102 having the following composition was prepared. As shown in the following, the polymerizable compound in the ink liquid 102 is composed of 99 wt % isobomyl acrylate, which is a monofunctional monomer, and 1 wt % hexane diol diacrylate, which is a bifunctional monomer.
Isobornyl acrylate (NK ester A-IB manufactured by Shin-Nakamura Chemical Co., Ltd.): 84.5 wt %
Hexane diol diacrylate (NK Ester A-HD-N manufactured by Shin-Nakamura Chemical Co., Ltd.): 0.8 wt %
Cyan pigment PB-15:3 (Irgalite Blue GLVO manufactured by Ciba Specialty Chemicals Ltd.): 5.0 wt %
Dispersant (SOLSPERS28000 manufactured by Avecia Inkjet Ltd.): 0.7 wt %
Photopolymerization initiator (IRGACURE907 manufactured by Ciba Specialty Chemicals Ltd.): 8.7 wt %
Surfactant (Megafac F444 manufactured by Dai-Nippon Ink & Chemicals, Inc.): 0.3 wt %

### <Ink Liquid 103 (Comparative Example)>

The polymerizable compound in the ink liquid 103 contains 2 wt % bifunctional monomer. The use of the ink liquid 103 corresponds to a comparative example.

The ink liquid 103 having the following composition was prepared. As shown in the following, the polymerizable compound contained in the ink liquid 103 is composed of 98 wt % isobornyl acrylate, which is a monofunctional monomer, and 2 wt % hexane diol diacrylate, which is a bifunctional monomer.
Isobornyl acrylate (NK ester A-IB manufactured by Shin-Nakamura Chemical Co., Ltd.): 83.6 wt %
Hexane diol diacrylate (NK Ester A-HD-N manufactured by Shin-Nakamura Chemical Co., Ltd.): 1.7 wt %
Cyan pigment PB-15:3 (Irgalite Blue GLVO manufactured by Ciba Specialty Chemicals Ltd.): 5.0 wt %
Dispersant (SOLSPERS28000 made by Avecia Inkjet Ltd.): 0.7 wt %
Photopolymerization initiator (IRGACURE907 manufactured by Ciba Specialty Chemicals Ltd.): 8.7 wt %
Surfactant (Megafac F444 manufactured by Dai-Nippon Ink & Chemicals, Inc.): 0.3 wt %

### <Ink Liquid 104 (Comparative Example)>

The polymerizable compound in the ink liquid 104 contains 3% bifunctional monomer. The use of the ink liquid 104 corresponds to a comparative example.

The ink liquid 104 having substantially the same composition as the ink liquid 102, except that the polymerizable compound is composed of 97 wt % isobomyl acrylate, which is a monofunctional monomer, and 3 wt % hexane diol diacrylate, which is a bifunctional monomer.

### <Ink Liquid 105 (Comparative Example)>

The polymerizable compound in the ink liquid 105 contains 25% bifunctional monomer. The use of the ink liquid 105 corresponds to a comparative example.

The ink liquid 105 having substantially the same composition as the ink liquid 102, except that the polymerizable compound is composed of 75 wt % isobomyl acrylate, which is a monofunctional monomer, and 25 wt % hexane diol diacrylate, which is a bifunctional monomer.

### <Ink Liquid 106 (Comparative Example)>

The polymerizable compound in the ink liquid 106 is composed only of bifunctional monomer. The use of the ink liquid 106 corresponds to a comparative example.

The ink liquid 106 having the following composition was prepared. As shown in the following, the polymerizable compound contained in the ink liquid 101 is only hexane diol diacrylate, which is a bifunctional monomer.
Hexane diol diacrylate (NK Ester A-HD-N manufactured by Shin-Nakamura Chemical Co., Ltd.): 85.3 wt %
Cyan pigment PB-15:3 (Irgalite Blue GLVO manufactured by Ciba Specialty Chemicals Ltd.): 5.0 wt %
Dispersant (SOLSPERS28000 manufactured by Avecia Inkjet Ltd.): 0.7 wt %
Photopolymerization initiator (IRGACURE907 manufactured by Ciba Specialty Chemicals Ltd.): 8.7 wt %
Surfactant (Megafac F444 manufactured by Dai-Nippon Ink & Chemicals, Inc.): 0.3 wt %

The viscosity of these ink liquids 101 to 106 falls within 10 mPa·s to 15 mPa·s, and the surface tension is in the range of 25 mN/m to 29 mN/m.

### Measurement of Softening Point

These ink liquids 101 to 106 were applied on a stainless steel plate having a thickness of 0.5 mm and irradiated with ultraviolet light to form a cured film, thereby obtaining test pieces. A measurement analogous to JISK 7206 in a thermo-mechanical analyzer (TMA) was carried out on these test patterns, the temperature at which a probe pierces 0.2 mm into the cured film was determined, and this temperature was taken to be the softening point of the cured ink.

The softening point of cured ink of the ink liquid 101 was determined to be 138° C., that of ink liquid 102 was 148° C., and that of the ink liquid 103 was 171° C., whereas the other samples did not soften in the range of 40 to 250° C. Incidentally, 250° C. is the ignition temperature of cotton or newspaper, and therefore a system which heats to a temperature equal to or higher than 250° C. is not practicable.

The prepared ink liquids 101 to 106 were loaded into the inkjet recording apparatus 10 according to the present embodiment, and a test image including step-shaped patch images in which the droplet ejection density changed successively in 8 steps from 0% to 100% was recorded on high-grade paper (C2 paper manufactured by Fuji Xerox Co., Ltd.) and the evaluations described below were carried out.

The temperature of the transfer heating roller 33 in the transfer unit 28 was changed in four stages: 100° C., 125° C., 150° C. and 175° C., and the nip pressure was 1.2 MPa. In this experiment, the temperature was determined by placing the recording medium (media) on top of the transfer heating roller 33 and then measuring the temperature of the medium by means of an infrared thermometer device. The temperature of the recording medium during transfer is thus measured directly, and it is thereby possible to indirectly determine the temperature of the transfer heating roller 33.

The temperature determination device is not limited to the example described above, and a mode is also possible in which a thermometer (temperature sensor) is provided on the transfer heating roller 33, and the temperature of the transfer heating roller 33 is measured directly. For example, a desirable mode is one in which the surface temperature of the transfer heating roller 33 is measured directly by means of a thermometer, and the temperature is controlled by feeding back the measurement results.

In the present evaluation experiment, droplets of ink were ejected toward the intermediate transfer body 16 of silicon rubber while varying the recording conditions, such as the ink used, the heating temperature, the droplet ejection conditions, and the like, and the state of the ink was observed with a microscope after sufficient irradiation of ultraviolet light but before transfer, to measure the dot size in a region of independent dots (by determining the average size of ten dots). Next, the intermediate transfer body was returned to its original position and passed through a transfer process, whereupon the recording medium onto which the image had been transferred was observed optically with a microscope to measure the size of the dots in the region of the recording medium corresponding to the region where the dots were measured on the intermediate transfer body before transfer, using a similar method. In this way, the ratio (hereinafter, simply referred to as “ratio of the dot diameter” or “dot diameter ratio”) of the dot diameter on the intermediate transfer body to the dot diameter on the recording medium was found.

Moreover, the surface of the recording medium was observed visually, obliquely from above, and the magnitude of the protrusion of the printed region was evaluated perceptively to judge whether or not the pile height was noticeable.

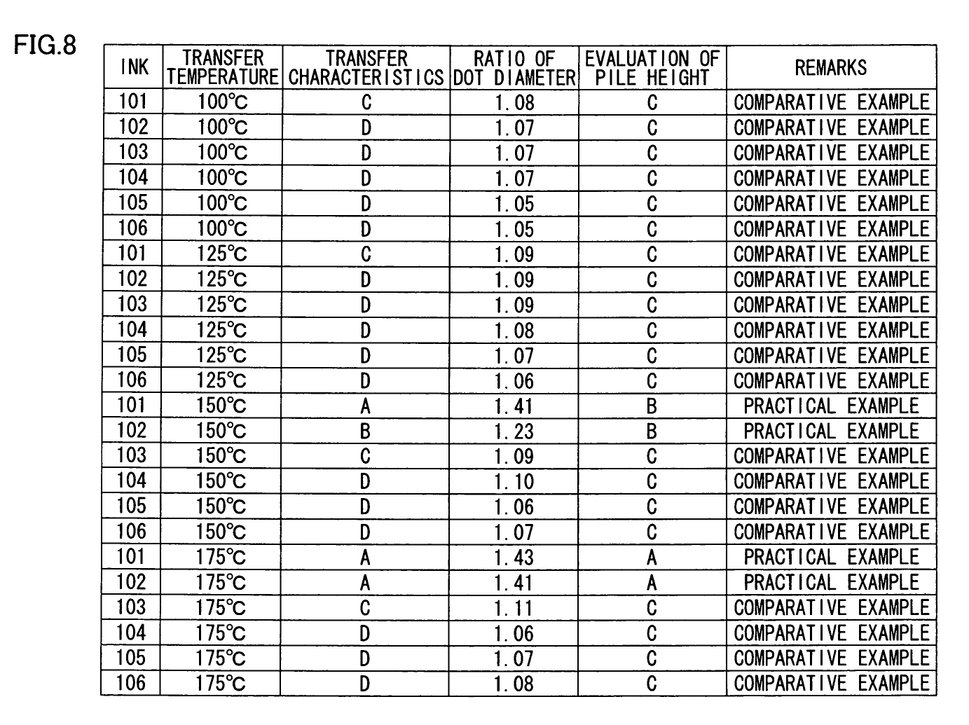

The results of this evaluation are shown in the table in FIG. 8. The criteria for the evaluation of transfer characteristics in the table are as follows.
A: No residue on intermediate transfer body; 100% transferred.
B: 90% or more transferred.
C: 80% or more transferred.
D: less than 80% transferred.

In the evaluation of the pile height, after transfer, the media was placed on a horizontal desk and illuminated from above with a fluorescent lamp, and the printed region was observed obliquely from above at an angle of 30 degrees to make percept evaluation of the protrusion of the printed region (pile height). The criteria for the evaluation of pile height in the table are as follows.
B: Pile height not noticeable.
C: Large pile height; protrusion creates unnatural appearance.

According to the evaluation results in FIG. 8, it can be seen that if the transfer temperature (heating temperature) is 125° C. or lower, in other words, if it is lower than the softening point, then the ratio of the dot diameter is less than 1.1, and hence the dots do not spread sufficiently in pressurization. Therefore, the transfer characteristics are poor and the pile height is large.

On the other hand, in a case where the transfer temperature (heating temperature) exceeds the softening point (in a case where the transfer temperature is 150° C. or 175° C.), the ink liquids 101 and 102 produce a dot diameter ratio of 1.2 or above, and therefore it can be seen that the dots are crushed and spread to a satisfactory extent. Therefore, the transfer characteristics are good and the pile height is low. In particular, notably beneficial effects were observed under conditions where the dot diameter ratio was 1.4 or above, and these conditions are denoted with the symbol “A” in FIG. 8.

As revealed by the table in FIG. 8, according to practical examples which use the present invention, by softening and crushing the dots (dots cured by polymerization) on the intermediate transfer body during transfer, the dot diameter on the recording medium is increased markedly with respect to the dot diameter that has been present on the intermediate transfer body, and the pile height is also improved markedly.

### Practical Example 2

Similar beneficial results were obtained even when the bifunctional monomer (hexane diol diacrylate) in Practical Example 1 was replaced with a trifunctional monomer (pentaerythritol triacrylate).

### Practical Example 3

Similar beneficial effects were obtained even when the monofunctional monomer (isobornyl acrylate) in Practical Example 1 was replaced with a monofunctional monomer (t-butyl acrylate or 2-ethylhexyl acrylate) of another type.

### Practical Example 4

Beneficial effects similar to the case of Practical Example 1 were obtained in cases where recording medium is changed among an art paper (Tokubishi Art made by Mitsubishi Paper Mills, Ltd.), a PET sheet (OHP sheet made by Fuji Xerox Co., Ltd.), and an OPP film (Pylen OP made by Teijin Ltd.). Consequently, it can be seen that the present invention can be applied to a wide range of media, from permeable media, into which ink can permeate, to non-permeable media.

### Practical Example 5

Ink liquids 201 to 206 were prepared similarly to the ink liquids 101 to 105, with the exception that the ink liquids 201 to 206 contain no photopolymerization initiator. These inks 201 to 206 were loaded on an apparatus similar to that shown in FIG. 1 (an intermediate transfer type of inkjet apparatus equipped with an apparatus which cures ink by radiating the electron beam on the intermediate transfer body), a similar evaluation to that described above was carried out, and similar results to Practical Example 1 were obtained.

### Second Embodiment

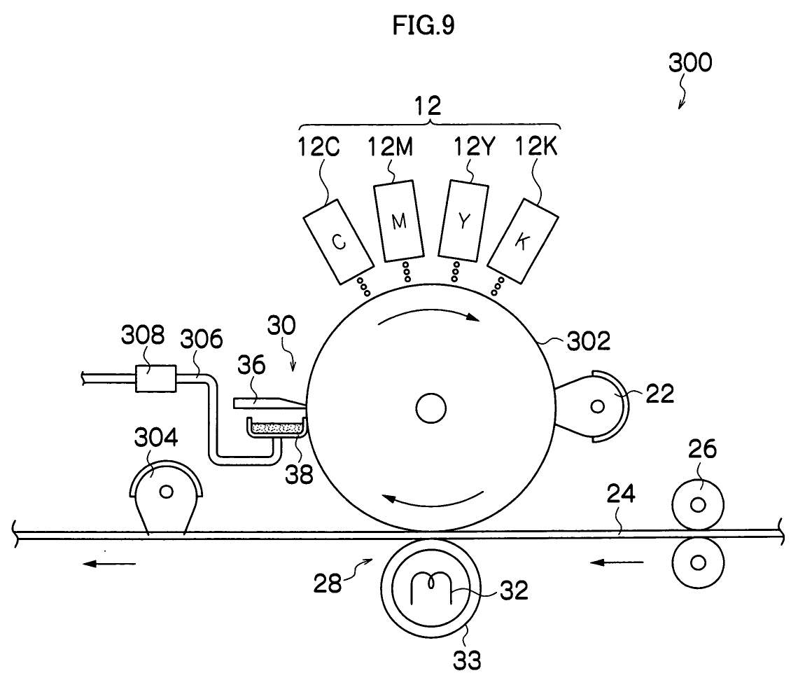

Next, a second embodiment of the present invention will be described. FIG. 9 is a general schematic drawing of an inkjet recording apparatus 300 according to the second embodiment of the present invention. Items which are the same as or similar to those in the first embodiment described above are labeled with the same or similar reference numerals and description thereof is omitted here.

As shown in FIG. 9, an intermediate transfer body 302 has a round cylindrical shape. In a mode where a drum-shaped member of this kind is used for the intermediate transfer body 302, a beneficial effect is obtained in that the throw distance (namely, the distance between the nozzle forming surfaces of the heads 12C, 12M, 12Y and 12K, and the intermediate transfer body 16) is stable. In a mode, on the other hand, where an intermediate transfer body 16 formed by a belt-shaped member as shown in FIG. 1 is used, it is possible to dispose the heads of a plurality of colors 12C, 12M, 12Y and 12K in a horizontal fashion, and therefore the arrangement structure of the heads is simplified.

Furthermore, in the mode shown in FIG. 9, an ultraviolet light source 304 is also provided which fully fixes the image that has been transferred, on the recording medium 24. The ultraviolet light source 304 used may have the same specifications as the ultraviolet light source 22 used to provisionally solidify the ink droplets deposited on the intermediate transfer body 302, but the applied energy required in order to fully fix the image on the recording medium 24 is greater than the applied energy used in provisionally solidifying the image on the intermediate transfer body 302, and therefore it is desirable that the ultraviolet light source 304 has a greater energy application capacity than the ultraviolet light source 22.

Moreover, in the mode shown in FIG. 9, a flow channel 306 which connects to a recovery unit 38 where the residual ink removed from the intermediate transfer body 302 is recovered, and a recycling unit 308 for recycling the residual ink, are provided. By recycling the residual ink in this way, it is possible to reuse the ultraviolet-curable polymerizable compound, which is highly expensive, thereby contributing to reducing the running costs of the inkjet recording apparatus 300.

In the mode shown in FIG. 1 also, a desirable mode is one which includes the ultraviolet light source 304 and the recycle processing unit 308 which recycles residual ink, which are shown in FIG. 9.

### Third Embodiment

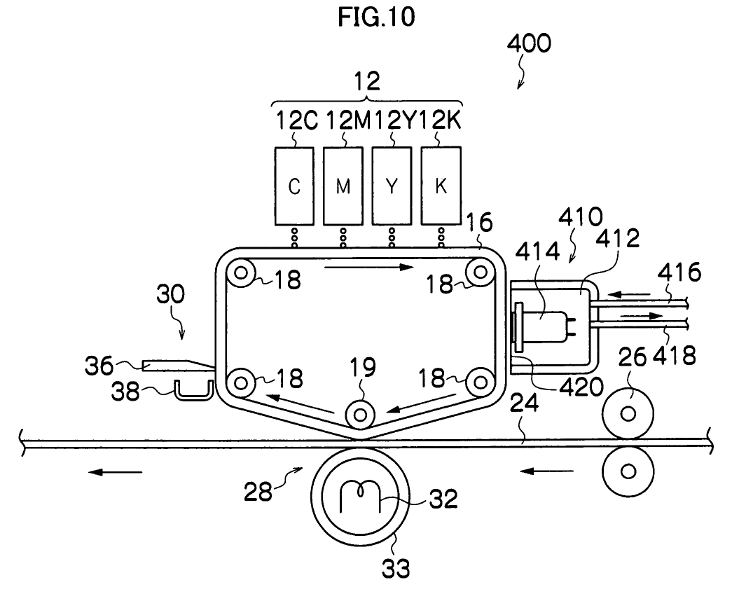

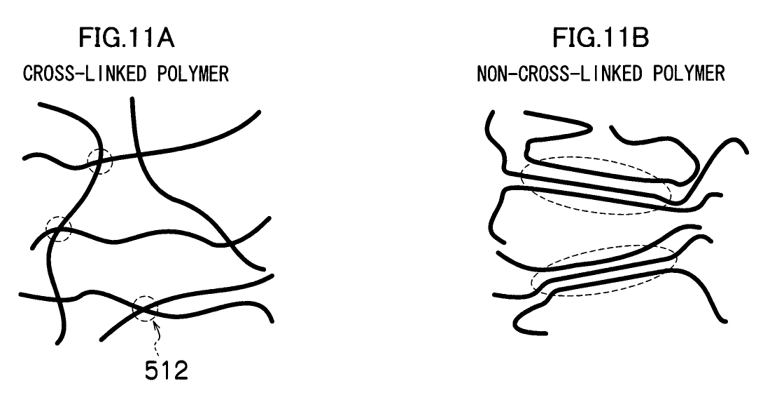

Next, a third embodiment of the present invention will be described. FIG. 10 is a general schematic drawing of an inkjet recording apparatus 400 according to a third embodiment. In FIG. 10, items which are the same as or similar to those of the composition shown in FIGS. 1 and 9 are labeled with the same reference numerals and description thereof is omitted here.

The inkjet recording apparatus 400 shown in FIG. 10 is an intermediate transfer type of apparatus which uses ink (an electron beam curable ink) containing a polymerizable compound which is cured by polymerization when irradiated with an electron beam, and the inkjet recording apparatus 400 includes an electron beam irradiation apparatus 410 as a device (a device which cures the ink by polymerization) which provisionally fixes the ink deposited on the intermediate transfer body 16, on the intermediate transfer body 16.

The electron beam irradiation apparatus 410 has a structure in which an electron beam generating source 414 is disposed inside a chamber (irradiation chamber) 412 into which nitrogen gas (N₂) has been introduced, and an electron beam is radiated onto the intermediate transfer body via an irradiation window 420 opposing the intermediate transfer body. The reference numeral 416 indicates a gas supply channel for introducing nitrogen gas (N₂), and reference numeral 418 is an exhaust channel.

In the inkjet recording apparatus 400 according to the present embodiment, the percentage of the monofunctional monomer in the polymerizable compound is no less than 99 wt % and no more than 100 wt %, and transfer to the recording medium 24 is carried out by heating and pressurizing to a temperature equal to or greater than the softening point by means of a transfer heating roller 33.

According to this composition, as well as reducing the pile height, it is also possible to improve transfer characteristics to the recording medium, and adhesive properties.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An inkjet recording method, comprising the steps of:
applying a liquid on an intermediate transfer body, the liquid containing an energy-beam polymerizable compound and a coloring material, the energy-beam polymerizable compound being constituted of a monofunctional polymerizable compound of which percentage in the energy-beam polymerizable compound is not less than 99 wt % and not more than 100 wt %;
radiating an energy beam on the liquid that has been applied on the intermediate transfer body, to produce a polymer of the liquid; and
transferring the polymer on the intermediate transfer body to a recording medium by pressurizing and heating the polymer to a temperature not lower than a softening temperature of the polymer.

2. The inkjet recording method as defined in claim 1, wherein a size of a dot of the polymer having been transferred to the recording medium in the transferring step is 1.2 or more times larger than a size of a corresponding dot of the polymer on the intermediate transfer body before the transferring step.

3. The inkjet recording method as defined in claim 1, wherein the liquid contains a photopolymerization initiator, and the energy beam is ultraviolet light.

4. The inkjet recording method as defined in claim 3, wherein the photopolymerization initiator is a photopolymerization radical generator.

5. An inkjet recording apparatus which transfers an image on an intermediate transfer body to a recording medium, comprising:
a liquid ejection device which ejects droplets of a liquid toward the intermediate transfer body, the liquid containing an energy-beam polymerizable compound and a coloring material, the energy-beam polymerizable compound being constituted of a monofunctional polymerizable compound of which percentage in the energy-beam polymerizable compound is not less than 99 wt % and not more than 100 wt %;
a liquid supply device which supplies the liquid to the liquid ejection device;
an energy-beam irradiation device which radiates an energy beam on the droplets of the liquid that have been deposited on the intermediate transfer body by the liquid ejection device, to produce a polymer of the liquid;
a heating device which heats the polymer of the liquid produced by irradiation of the energy beam, to a temperature not lower than a softening temperature of the polymer; and
a pressurizing device which pressurizes the polymer that has been heated to the temperature not lower than the softening temperature by the heating device, while causing the polymer to be in contact with the recording medium.
